(19) United States
(12) Patent Application Publication
(10) Pub. No.: US 2024/0107521 A1
(43) Pub. Date: Mar. 28, 2024

(54) METHOD AND APPARATUS FOR PUSCH REPETITION

(71) Applicant: Telefonaktiebolaget LM Ericsson (publ), Stockholm (SE)

(72) Inventors: Ling SU, Beijing (CN); Zhipeng LIN, Nanjing, Jiangsu (CN); Yuande TAN, Beijing (CN)

(21) Appl. No.: 18/271,528

(22) PCT Filed: Jan. 11, 2022
(86) PCT No.: PCT/EP2022/050401

§ 371 Date: Jul. 10, 2023

(30) Foreign Application Priority Data
Jan. 11, 2021 (WO) PCT/CN2021/071143
May 11, 2021 (WO) PCT/CN2021/093169

(51) Int. Cl. H04W 72/1268; H04L 1/08; H04L 1/1607; H04W 72/0446

(52) U.S. Cl. CPC H04W 72/1268; H04L 1/08; H04L 1/1642; H04W 72/0446

(57) ABSTRACT

The present disclosure provides a method in a terminal device. The method includes: receiving, from a network node, at least one of cell specific Time Division Duplex, TDD, uplink-downlink configuration information and User Equipment, UE, specific TDD uplink-downlink configuration information; and determining whether a slot is available for Physical Uplink Shared Channel, PUSCH, repetition based on the at least one of the cell specific TDD uplink-downlink configuration information and the UE specific TDD uplink-downlink configuration information.

### FIELD OF THE INVENTION

The present disclosure generally relates to communication networks, and more specifically, to method and apparatus for physical uplink shared channel (PUSCH) repetition.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE) and new radio (NR) networks are expected to achieve larger coverage. For example, in order to achieve larger PUSCH coverage, PUSCH repetition may be performed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Various embodiments of the present disclosure mainly aim at providing methods, apparatus and computer programs for PUSCH repetition. Other features and advantages of embodiments of the present disclosure will also be understood from the following description of specific embodiments when read in conjunction with the accompanying drawings, which illustrate, by way of example, the principles of embodiments of the present disclosure.

According to a first aspect of the present disclosure, a method performed by a terminal device is provided. The method includes: determining whether a slot is an available slot for a physical uplink shared channel (PUSCH) repetition based at least in part on an amount X of symbols available for PUSCH transmission among L scheduled symbols for the PUSCH transmission in the slot; and performing PUSCH repetitions through K available slots, wherein K is an amount of repetitions.

In an embodiment, a slot may be determined as an available slot in response to X being equal to L.

In an embodiment, redundancy version (RV) cycling may be counted based on the determined available slots for the PUSCH transmission.

In an embodiment, the method may further include: transmitting to a network node a report on whether the terminal device is capable of supporting an extended number of PUSCH repetitions. The extended number of PUSCH repetitions is greater than a number of PUSCH repetitions supported by a terminal device that is not capable of supporting the extended number of PUSCH repetitions.

In an embodiment, a value of K may depend on a first type of the PUSCH repetition.

In an embodiment, the method may further include: receiving configuration information about one or more PUSCH repetition types from a network node. The one or more PUSCH repetition types include the first type of the PUSCH repetition, and each of the one or more PUSCH repetition types supports at least one candidate value of K.

In an embodiment, the method may further include: determining K and which of the one or more PUSCH repetition types is to be used by the terminal device, based at least in part on RRC signaling, DCI signaling and/or a time domain resource assignment (TDRA) table. The TDRA table is a default table or signaled from a network node.

In an embodiment, the first type of the PUSCH repetition and a different type of the one or more PUSCH repetition types which is determined based at least in part on the TDRA tables may correspond to separate TDRA tables.

In an embodiment, the first type of the PUSCH repetition and a different type of the one or more PUSCH repetition types which is determined based at least in part on the TDRA tables may correspond to a same TDRA table.

In an embodiment, the first type of the PUSCH repetition may support an extended number of PUSCH repetitions.

In an embodiment, the one or more PUSCH repetition types may further include one or more of: a PUSCH repetition type A which supports up to 16 repetitions, a PUSCH repetition type A which supports an extended number of PUSCH repetitions, and a PUSCH repetition type B. The one or more PUSCH repetition types are configured by an RRC message.

In an embodiment, the one or more PUSCH repetition types may include: the first type of the PUSCH repetition, and a PUSCH repetition type A which supports an extended number of PUSCH repetitions, and wherein which of the configured types is to be used by the terminal device is indicated by RRC signaling, DCI signaling and/or a TDRA table.

In an embodiment, the report may include a report on one or more PUSCH repetition types supported by the terminal device.

In an embodiment, the one or more PUSCH repetition types may include one or more of: a PUSCH repetition type A which supports up to 16 repetitions, a first type of the PUSCH repetition, a PUSCH repetition type A which supports an extended number of PUSCH repetitions, and a PUSCH repetition type B. According to the first type, only the PUSCH transmission in an available slot is counted for PUSCH repetition.

In an embodiment, the terminal device may be configured with one of the one or more PUSCH repetition types.

In an embodiment, the terminal device may be configured, by an RRC message, with at least two of: the first type of the PUSCH repetition, the PUSCH repetition type A which supports an extended number of PUSCH repetitions, and the PUSCH repetition type B.

In an embodiment, the first type of the PUSCH repetition and the PUSCH repetition type A which supports an extended number of PUSCH repetitions may correspond to a same TDRA table.

In an embodiment, the extended number may be up to 32.

According to a second aspect of the present disclosure, a method performed by a network node is provided. The method includes: determining whether a slot is an available slot for a physical uplink shared channel, PUSCH, repetition based at least in part on an amount X of symbols available for PUSCH transmission among L scheduled symbols for the PUSCH transmission in the slot; and receiving PUSCH repetitions through equal to or less than K available slots, wherein K is a number of repetitions.

In an embodiment, a slot may be determined as an available slot in response to X being equal to L.

In an embodiment, RV cycling may be counted based on the determined available slots for the PUSCH transmission.

In an embodiment, the method may further include: receiving a report on whether the terminal device is capable of supporting extended number of PUSCH repetitions. The extended number of PUSCH repetitions is greater than a number of PUSCH repetitions supported by a terminal device that is not capable of supporting the extended number of PUSCH repetitions.

In an embodiment, a value of K may depend on a first type of the PUSCH repetition.

In an embodiment, the method may further include: sending to the terminal device configuration information about one or more PUSCH repetition types. The one or more PUSCH repetition types include the first type of the PUSCH repetition, and each of the one or more PUSCH repetition types supports at least one candidate value of K.

In an embodiment, the method may further include: informing the terminal device of K and which of the one or more PUSCH repetition type is to be used by the terminal device based at least in part by RRC signaling, DCI signaling and/or a TDRA table. The TDRA table is a default table or signaled from a network node.

In an embodiment, the first type of the PUSCH repetition and a different type of the one or more PUSCH repetition type which is determined based at least in part on the TDRA tables may correspond to separate TDRA tables.

In an embodiment, the first type of the PUSCH repetition and a different type of the one or more PUSCH repetition type which is determined based at least in part on the TDRA tables may correspond to a same TDRA table.

In an embodiment, the first type of the PUSCH repetition may support an extended number of PUSCH repetitions.

In an embodiment, the one or more PUSCH repetition types may further include one or more of: a PUSCH repetition type A which supports up to 16 repetitions, a PUSCH repetition type A which supports an extended number of PUSCH repetitions, and a PUSCH repetition type B. The one or more PUSCH repetition types are configured by an RRC message.

In an embodiment, the one or more PUSCH repetition types may include: the first type of the PUSCH repetition, and the PUSCH repetition type A which supports an extended number of PUSCH repetitions. The method may further include: indicating which of the configured types is to be used by the terminal device by RRC signaling, DCI signaling and/or a TDRA table.

In an embodiment, the report may include a report on one or more PUSCH repetition types supported by the terminal device.

In an embodiment, the one or more PUSCH repetition types may include one or more of: a PUSCH repetition type A which supports up to 16 repetitions, a first type of the PUSCH repetition, a PUSCH repetition type A which supports an extended number of PUSCH repetitions, and a PUSCH repetition type B. According to the first type, only the PUSCH transmission in an available slot is counted for PUSCH repetition.

In an embodiment, the method may further include: configuring the terminal device with one of the one or more PUSCH repetition types.

In an embodiment, the method may further include: configuring the terminal device, by an RRC message, with at least two of: the first type of the PUSCH repetition, the PUSCH repetition type A which supports an extended number of PUSCH repetitions, and the PUSCH repetition type B.

In an embodiment, the first type of the PUSCH repetition and the PUSCH repetition type A which supports an extended number of PUSCH repetitions may correspond to a same TDRA table.

In an embodiment, the extended number may be up to 32.

According to a third aspect of the present disclosure, a method in a terminal device is provided. The method includes: receiving, from a network node, at least one of cell specific Time Division Duplex (TDD) uplink-downlink configuration information and User Equipment (UE) specific TDD uplink-downlink configuration information; and determining whether a slot is available for PUSCH repetition based on the at least one of the cell specific TDD uplink-downlink configuration information and the UE specific TDD uplink-downlink configuration information.

In an embodiment, the operation of determining may include: determining the slot to be unavailable for PUSCH repetition when the slot is configured as downlink by the at least one of the cell specific TDD uplink-downlink configuration information and the UE specific TDD uplink-downlink configuration information.

In an embodiment, the operation of determining may include: determining the slot to be available for PUSCH repetition when the slot includes no symbol that is configured as downlink by the at least one of the cell specific TDD uplink-downlink configuration information and the UE specific TDD uplink-downlink configuration information and overlaps any symbol in a set of symbols indicated by PUSCH Time Domain Resource Allocation (TDRA).

In an embodiment, the operation of determining may include: determining the slot to be available for PUSCH repetition when the slot is configured as uplink by the at least one of the cell specific TDD uplink-downlink configuration information and the UE specific TDD uplink-downlink configuration information, or includes a set of symbols, indicated by PUSCH TDRA, each configured as uplink or flexible by the at least one of the cell specific TDD uplink-downlink configuration information and the UE specific TDD uplink-downlink configuration information.

In an embodiment, the method may further include: receiving, from the network node, control information indicating the at least one of the cell specific TDD uplink-downlink configuration information and the UE specific TDD uplink-downlink configuration information to be used for determining whether the slot is available for PUSCH repetition.

In an embodiment, the operation of determining may be based on the cell specific TDD uplink-downlink configuration information when only the cell specific TDD uplink-downlink configuration information is received, or the operation of determining may be based on both the cell specific TDD uplink-downlink configuration information and the UE specific TDD uplink-downlink configuration information when both the cell specific TDD uplink-downlink configuration information and the UE specific TDD uplink-downlink configuration information are received.

In an embodiment, the method may further include: transmitting the PUSCH repetition in the slot when each symbol in the set of symbols that is configured as flexible by the at least one of the cell specific TDD uplink-downlink configuration information and the UE specific TDD uplink-downlink configuration information is indicated as uplink in a dynamic SFI for the slot as received from the network node.

In an embodiment, the PUSCH repetition may include a Dynamic Grant (DG)-PUSCH, a Type-1 Configured Grant (CG)-PUSCH, or a Type-2 CG-PUSCH.

According to a fourth aspect of the present disclosure, a method in a terminal device is provided. The method includes: determining a slot to be available for PUSCH repetition in absence of cell specific TDD uplink-downlink configuration information and UE specific TDD uplink-downlink configuration information from a network node for the slot.

In an embodiment, the method may further include: transmitting the PUSCH repetition in the slot when each symbol in a set of symbols indicated by PUSCH TDRA is indicated as uplink in a dynamic SFI for the slot as received from the network node.

In an embodiment, the cell specific TDD uplink-downlink configuration information may be tdd-UL-DL-ConfigurationCommon and the UE specific TDD uplink-downlink configuration information may be tdd-UL-DL-ConfigurationDedicated.

In an embodiment, the PUSCH repetition may include a DG-PUSCH, a Type-1 CG-PUSCH, or a Type-2 CG-PUSCH.

According to a fifth aspect of the present disclosure, a method in a network node is provided. The method includes: transmitting, to a terminal device, at least one of cell specific TDD uplink-downlink configuration information and UE specific TDD uplink-downlink configuration information; and determining whether a slot is available for PUSCH repetition based on the at least one of the cell specific TDD uplink-downlink configuration information and the UE specific TDD uplink-downlink configuration information.

In an embodiment, the operation of determining may include: determining the slot to be unavailable for PUSCH repetition when the slot is configured as downlink by the at least one of the cell specific TDD uplink-downlink configuration information and the UE specific TDD uplink-downlink configuration information.

In an embodiment, the operation of determining may include: determining the slot to be available for PUSCH repetition when the slot includes no symbol that is configured as downlink by the at least one of the cell specific TDD uplink-downlink configuration information and the UE specific TDD uplink-downlink configuration information and overlaps any symbol in a set of symbols indicated by PUSCH TDRA.

In an embodiment, the operation of determining may include: determining the slot to be available for PUSCH repetition when the slot is configured as uplink by the at least one of the cell specific TDD uplink-downlink configuration information and the UE specific TDD uplink-downlink configuration information, or includes a set of symbols, indicated by PUSCH TDRA, each configured as uplink or flexible by the at least one of the cell specific TDD uplink-downlink configuration information and the UE specific TDD uplink-downlink configuration information.

In an embodiment, the method may further include: transmitting, to the terminal device, control information indicating the at least one of the cell specific TDD uplink-downlink configuration information and the UE specific TDD uplink-downlink configuration information to be used for determining whether the slot is available for PUSCH repetition.

In an embodiment, the method may further include: transmitting, to the terminal device, a dynamic SFI for the slot, the dynamic SFI indicating each symbol in the set of symbols that is configured as flexible by the at least one of the cell specific TDD uplink-downlink configuration information and the UE specific TDD uplink-downlink configuration information as uplink; and receiving the PUSCH repetition in the slot.

In an embodiment, the PUSCH repetition may include a DG-PUSCH, a Type-1 CG-PUSCH, or a Type-2 CG-PUSCH.

According to a sixth aspect of the present disclosure, a method in a network node is provided. The method includes: determining a slot to be available for PUSCH repetition by a terminal device when cell specific TDD uplink-downlink configuration information and UE specific TDD uplink-downlink configuration information are not provided for the slot from the network node to the terminal device.

In an embodiment, the method may further include: transmitting, to the terminal device, a dynamic SFI for the slot, the dynamic SFI indicating each symbol in a set of symbols indicated by PUSCH TDRA is indicated as uplink; and receiving the PUSCH repetition in the slot.

In an embodiment, the cell specific TDD uplink-downlink configuration information may be tdd-UL-DL-ConfigurationCommon and the UE specific TDD uplink-downlink configuration information may be tdd-UL-DL-ConfigurationDedicated.

In an embodiment, the PUSCH repetition may include a DG-PUSCH, a Type-1 CG-PUSCH, or a Type-2 CG-PUSCH.

According to a seventh aspect of the present disclosure, a terminal device is provided. The terminal device includes a processor and a memory. The memory contains instructions executable by the processor whereby the terminal device is operative to perform the method according to the above first, third, or fourth aspect.

According to a fourth aspect of the present disclosure, a computer-readable storage medium is provided. The computer-readable storage medium has computer-readable instructions stored thereon. The computer-readable instructions, when executed by a processor of a terminal device, configure the terminal device to perform the method according to the above first, third, or fourth aspect.

According to a seventh aspect of the present disclosure, a network node is provided. The network node includes a processor and a memory. The memory contains instructions executable by the processor whereby the network node is operative to perform the method according to the above second, fifth, or sixth aspect.

According to an eighth aspect of the present disclosure, a computer-readable storage medium is provided. The computer-readable storage medium has computer-readable instructions stored thereon. The computer-readable instructions, when executed by a processor of a network node, configure the network node to perform the method according to the above second, fifth, or sixth aspect.

With some embodiments of the present disclosure, a slot available for PUSCH repetition can be determined, such that the PUSCH repetition can be performed properly.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating an exemplary procedure of PUSCH repetition according to an embodiment of the present disclosure;

FIG. 1B is a diagram illustrating an exemplary procedure of PUSCH repetition according to another embodiment of the present disclosure;

FIG. 2A is a flowchart illustrating a method according to some embodiments of the present disclosure;

FIG. 2B is a flowchart illustrating a further step of the method as shown in FIG. 2A according to some embodiments of the present disclosure;

FIG. 3A is a flowchart illustrating another method according to some embodiments of the present disclosure;

FIG. 3B is a flowchart illustrating a further step of the method as shown in FIG. 3A according to some embodiments of the present disclosure;

FIG. 4A is a flowchart illustrating still another method according to some embodiments of the present disclosure;

FIG. 5A is a flowchart illustrating yet still another method according to some embodiments of the present disclosure;

FIG. 6 is a flowchart illustrating a method according to some embodiments of the present disclosure;

FIG. 7 is a flowchart illustrating another method according to some embodiments of the present disclosure;

FIG. 8 is a flowchart illustrating yet another method according to some embodiments of the present disclosure;

FIG. 9 is a flowchart illustrating still another method according to some embodiments of the present disclosure;

FIG. 10A is a block diagram illustrating an apparatus according to some embodiments of the present disclosure;

FIG. 10B is a block diagram showing a terminal device according to an embodiment of the disclosure;

FIG. 10C is a block diagram showing a base station according to an embodiment of the disclosure;

FIG. 10D is a block diagram showing a terminal device according to another embodiment of the disclosure;

FIG. 10E is a block diagram showing a base station according to another embodiment of the disclosure;

FIG. 10F is a block diagram showing a terminal device according to another embodiment of the disclosure;

FIG. 10G is a block diagram showing a base station according to another embodiment of the disclosure;

FIG. 101H is a block diagram showing a terminal device according to another embodiment of the disclosure;

FIG. 101 is a block diagram showing a base station according to another embodiment of the disclosure;

FIG. 11 is a block diagram illustrating a telecommunication network connected via an intermediate network to a host computer in accordance with some embodiments of the present disclosure;

FIG. 12 is a block diagram illustrating a host computer communicating via a base station with a UE over a partially wireless connection in accordance with some embodiments of the present disclosure;

FIG. 13 is a flowchart illustrating a method implemented in a communication system, in accordance with an embodiment of the present disclosure;

FIG. 14 is a flowchart illustrating a method implemented in a communication system, in accordance with an embodiment of the present disclosure;

FIG. 15 is a flowchart illustrating a method implemented in a communication system, in accordance with an embodiment of the present disclosure; and

FIG. 16 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. As described previously, in order to enlarge PUSCH coverage, a terminal device such as a UE may need to perform slot aggregation.

Slot aggregation for PUSCH is supported in Rel-15 and renamed to PUSCH Repetition Type A in Rel-16. The name “PUSCH repetition Type A” is used even if there is only a single repetition, i.e., no slot aggregation. In Rel. 15, a PUSCH transmission that overlaps with downlink (DL) symbols is not transmitted.

For downlink control information (DCI) granted multi-slot transmission (PDSCH/PUSCH) vs semi-static DL/UL assignment:
If semi-static DL/UL assignment configuration of a slot has no direction confliction with scheduled PDSCH/PUSCH assigned symbols, the PDSCH/PUSCH in that slot is received/transmitted;
If semi-static DL/UL assignment configuration of a slot has direction confliction with scheduled PDSCH/PUSCH assigned symbols, the PDSCH/PUSCH transmission in that slot is not received/transmitted, which results in reduction of the effective number of repetitions.

In Rel. 15, the number of repetitions is semi-statically configured by RRC parameter pusch-AggregationFactor. At most 8 repetitions are supported.

pusch-AggregationFactor ENULMERATED {n2, n4, n8}

Early termination of PUSCH repetitions was discussed in R14 NR SI in RAN1#88 with below agreement, but not standardized finally.

R1-1703868 WF on grant-free repetitions Huawei, HiSilicon, Nokia, ABS, ZTE, ZTE Microelectronics, CATT, Convida Wireless, CATR, OPPO, Inter Digital, Fujitsu

Agreements:

For UE configured with K repetitions for a transport block (TB) transmission with/without grant, the UE can continue repetitions (FFS can be different RV versions, FFS different Modulation and Coding Scheme (MCS)) for the TB until one of the following conditions is met:
if an UL grant is successfully received for a slot/mini-slot for the same TB;
   FFS: How to determine the grant is for the same TB
FFS: An acknowledgement/indication of successful receiving of that TB from gNB
the number of repetitions for that TB reaches K;
FFS: Whether it is possible to determine if the grant is for the same TB
Note that this does not assume that UL grant is scheduled based on the slot whereas grant free allocation is based on mini-slot (vice versa)
Note that other termination condition of repetition may apply

A new repetition format PUSCH repetition Type B is supported in Rel-16, which PUSCH repetition allows back-to-back repetition of PUSCH transmissions. The biggest difference between the two types is that repetition Type A only allows a single repetition in each slot, with each repetition occupying the same symbols. Using this format with a PUSCH length shorter than 14 introduces gaps between repetitions, increasing the overall latency. The other change compared to Rel. 15 is how the number of repetitions is signaled. In Rel. 15, the number of repetitions is semi-statically configured, while in Rel. 16 the number of repetitions can be indicated dynamically in DCI. This applies both to dynamic grants and configured grants type 2.

In NR R16, invalid symbols for PUSCH repetition Type B include reserved UL resources. The invalid symbol pattern indicator field is configured in the scheduling DCI. Segmentation occurs around symbols that are indicated as DL by the semi-static TDD pattern and invalid symbols.

Below shows the signaling of number of repetitions.

From 38.214 V16.2.0:

When the UE is scheduled to transmit a transport block and no CSI report, or the UE is scheduled to transmit a transport block and a CSI report(s) on PUSCH by a DCI, the Time domain resource assignment field value m of the DCI provides a row index m+1 to an allocated table. The determination of the used resource allocation table is defined in Clause 6.1.2.1.1. The indexed row defines the slot offset K₂, the start and length indicator SLIV, or directly the start symbol S and the allocation length L, the PUSCH mapping type, and the number of repetitions (if numberOfRepetitions-r16 is present in the resource allocation table) to be applied in the PUSCH transmission.

For PUSCH repetition Type A, when transmitting PUSCH scheduled by DCI format 0_1 or 0_2 in PDCCH with CRC scrambled with Cell Radio Network Temporary Identifier (C-RNTI), MCS-C-RNTI, or Configured Scheduling RNTI (CS-RNTI) with Network Device Interface (NDI)=1, the number of repetitions K is determined as:
if numberofrepetitions is present in the resource allocation table, the number of repetitions K is equal to numberofrepetitions;
elseif the UE is configured with pusch-AggregationFactor, the number of repetitions K is equal to pusch-AggregationFactor;
otherwise K=1.

For the PUSCH repetition for type A, intra-slot and inter-slot frequency hopping are supported. UE is configured for frequency hopping by the higher layer parameter frequencyHopping-ForDCIFormat0_2 in pusch-Config for PUSCH transmission scheduled by DCI format 0_2, and by frequencyHopping provided in pusch-Config for PUSCH transmission scheduled by a DCI format other than 0_2, and by frequencyHopping provided in configuredGrantConfig for configured PUSCH transmission. One of two frequency hopping modes can be configured:
Intra-slot frequency hopping, applicable to single slot and multi-slot PUSCH transmission.
Inter-slot frequency hopping, applicable to multi-slot PUSCH transmission.

In case of resource allocation type 2, the UE transmits PUSCH without frequency hopping.

In case of resource allocation type 1, whether or not transform precoding is enabled for PUSCH transmission, the UE may perform PUSCH frequency hopping, if the frequency hopping field in a corresponding detected DCI format or in a random access response UL grant is set to 1, or if for a Type 1 PUSCH transmission with a configured grant the higher layer parameter frequencyHoppingOffset is provided, otherwise no PUSCH frequency hopping is performed.

For a PUSCH scheduled by RAR UL grant, fallbackRAR UL grant, or by DCI format 0_0 with CRC scrambled by TC-RNTI, frequency offsets are obtained as described in clause 8.3 of [6, TS 38.213]. For a PUSCH scheduled by DCI format 0_0/0_1 or a PUSCH based on a Type2 configured UL grant activated by DCI format 0_0/0_1 and for resource allocation type 1, frequency offsets are configured by higher layer parameter frequencyHoppingOffsetLists in pusch-Config. For a PUSCH scheduled by DCI format 0_2 or a PUSCH based on a Type2 configured UL grant activated by DCI format 0_2 and for resource allocation type 1, frequency offsets are configured by higher layer parameter frequencyHoppingOffsetLists-ForDCIFormat0_2 in pusch-Config.
When the size of the active BWP is less than 50 PRBs, one of two higher layer configured offsets is indicated in the UL grant.
When the size of the active BWP is equal to or greater than 50 PRBs, one of four higher layer configured offsets is indicated in the UL grant.

For PUSCH based on a Type1 configured UL grant, the frequency offset is provided by the higher layer parameter frequencyHoppingOffset in rrc-Configu redUplinkGrant.

For a MsgA PUSCH the frequency offset is provided by the higher layer parameter as described in [6, TS 38.213].

In case of intra-slot frequency hopping, the starting resource block (RB) in each hop is given by:

$$\\ {RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix}$$

where nₛ^{μ} is the current slot number within a radio frame, where a multi-slot PUSCH transmission can take place, RBₛₜₐᵣₜ is the starting RB within the UL BWP, as calculated from the resource block assignment information of resource allocation type 1 and RB_{offset} is the frequency offset in RBs between the two frequency hops.

Format DCI0_1 in 38.212 V16.1.0:

Time Domain Resource Assignment—0, 1, 2, 3, 4, 5, or 6 Bits
If the higher layer parameter PUSCH-TimeDomainResourceAllocationList-ForDCIformat0_1 is not configured and if the higher layer parameter pusch-TimeDomainAllocationList is configured, 0, 1, 2, 3, or 4 bits as defined in Clause 6.1.2.1 of [6, TS38.214]. The bitwidth for this field is determined as ┌log₂(I)┐ bits, the number of entries in the higher layer parameter pusch-TimeDomainAllocationList or pusch-TimeDomainAllocationList-r16;
If the higher layer parameter PUSCH-TimeDomainResourceAllocationList-ForDCIformat0_1 is configured, 0, 1, 2, 3, 4, 5 or 6 bits as defined in Clause 6.1.2.1 of [6, TS38.214]. The bitwidth for this field is determined as ┌log₂(I)┐ bits, where I is the number of entries in the higher layer parameter PUSCH-TimeDomainResourceAllocationList-ForDCIformat0_1;
otherwise the bitwidth for this field is determined as ┌log₂(I)┐ bits, where I is the number of entries in the default table.

PUSCH-Config information element

| | |
|---|---|
| pusch-RepTypeIndicatorForDCI-Format0-2-r16 | ENUMERATED { pusch- |

RepTypeA, pusch-RepTypeB} OPTIONAL, -- Need R

| | |
|---|---|
| pusch-RepTypeIndicatorForDCI-Format0-1-r16 | ENUMERATED { pusch-RepTypeA, |

pusch-RepTypeB} OPTIONAL, -- Need R

| | |
|---|---|
| pusch-TimeDomainAllocationList | SetupRelease { PUSCH- |

TimeDomainResourceAllocationList }

| | |
|---|---|
| pusch-AggregationFactor | ENUMERATED { n2, n4, n8 } |

OPTIONAL, -- Need S
pusch-TimeDomainAllocationListForDCI-Format0-1-r16 SetupRelease { PUSCH-
TimeDomainResourceAllocationList-r16 }
pusch-TimeDomainAllocationListForDCI-Format0-2-r16 SetupRelease { PUSCH-
TimeDomainResourceAllocationList-r16 }

PUSCH-TimeDomainResourceAllocation information element
-- ASN1START
-- TAG-PUSCH-TIMEDOMAINRESOURCEALLOCATIONLIST-START
PUSCH-TimeDomainResourceAllocationList ::= SEQUENCE (SIZE (1..maxNrofUL-
Allocations)) OF PUSCH-TimeDomainResourceAllocation
PUSCH-TimeDomainResourceAllocation ::= SEQUENCE {

| | |
|---|---|
| k2 | INTEGER(0..32) |

OPTIONAL, -- Need S

| | |
|---|---|
| mappingType | ENUMERATED {typeA, typeB}, |
| startSymbolAndLength | INTEGER (0..127) |

}
PUSCH-TimeDomainResourceAllocationList-r16 ::= SEQUENCE (SIZE(1..maxNrofUL-
Allocations-r16)) OF PUSCH-TimeDomainResourceAllocation-r16
PUSCH-TimeDomainResourceAllocation-r16 ::= SEQUENCE {

| | |
|---|---|
| k2-r16 | INTEGER(0..32) OPTIONAL, -- |

Need S

| | |
|---|---|
| puschAllocationList-r16 | SEQUENCE |

(SIZE(1..maxNrofMultiplePUSCHs-r16)) OF PUSCH-Allocation-r16,
...
}
PUSCH-Allocation-r16 ::= SEQUENCE {

| | |
|---|---|
| mappingType-r16 | ENUMERATED {typeA, typeB} |

OPTIONAL, -- Cond NotFormat01-02-Or-TypeA

| | |
|---|---|
| startSymbolAndLength-r16 | INTEGER (0..127) |

OPTIONAL, -- Cond NotFormat01-02-Or-TypeA

| | |
|---|---|
| startSymbol-r16 | INTEGER (0..13) |

OPTIONAL, -- Cond RepTypeB

| | |
|---|---|
| length-r16 | INTEGER (1..14) |

OPTIONAL, -- Cond RepTypeB

| | |
|---|---|
| numberOfRepetitions-r16 | ENUMERATED {n1, n2, n3, n4, n7, n8, |

n12, n16} OPTIONAL, -- Cond Format01-02
...
}
-- TAG-PUSCH-TIMEDOMAINRESOURCEALLOCATIONLIST-STOP
-- ASN1STOP

| | |
|---|---|
| maxNrofUL-Allocations | INTEGER ::= 16 -- Maximum number of |

PUSCH time domain resource allocations.

| | |
|---|---|
| maxNrofUL-Allocations-r16 | INTEGER ::= 64 -- Maximum number of PUSCH time |

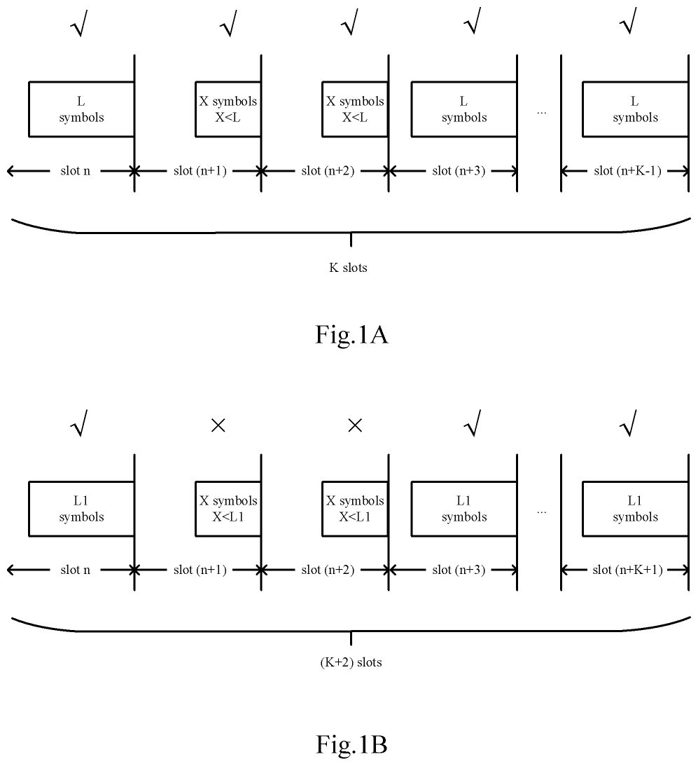

PUSCH has been identified as coverage bottleneck in scenarios of FR1 and FR2. PUSCH repetition is the method to improve PUSCH coverage. For PUSCH repetition type A, the number of repetitions is configured by RRC in Rel-15, and dynamic indication of number of repetitions is introduced in Rel-16. However, the number of repetitions is counted on the basis of contiguous slots. In case of collision with DL slots for TDD, the PUSCH transmission is cancelled, but still counted. Then, the actual number of PUSCH repetitions is less than the configured number of repetitions and the coverage performance of PUSCH is degraded significantly. An exemplary procedure of PUSCH repetition is illustrated in FIG. 1A.

In the example of FIG. 1A, a UE may be instructed to perform PUSCH repetitions through K slots, and the PUSCH repetition is instructed to be performed in L scheduled symbols in each slot, for example, the last 14 symbols in each slot. In some slots, such as slot n, slot (n+3), all the L scheduled symbols are available for PUSCH repetition. In some other slots, such as slot (n+1), slot (n+2), only X (X<L) symbols among the L scheduled symbols are available for PUSCH repetition. The symbol among the L scheduled symbols, which is a UL symbol, or a semi-static flexible symbol under certain dynamic SFI configuration, may be referred to as an available symbol in the context. Specifically, the available symbol is a symbol in a slot for PUSCH transmission except the following: a DL symbol, including semi-static flexible symbols which are later indicated as downlink by DCI format 2_0 with an SFI-index field; a GAP symbol between UL and DL; and invalid symbol pattern. The symbol among the L scheduled symbols which is a DL symbol, including semi-static flexible symbols which are later indicated as downlink by DCI format 2_0 with an SFI-index field; a GAP symbol between UL and DL; and invalid symbol pattern may be referred to as an unavailable symbol in the context. The slot having L available symbols for PUSCH transmission may be referred to as an available slot. The slot having less than L available symbols for PUSCH transmission may be referred to as an unavailable slot. In the example of FIG. 1A, the K slots may include (K-2) slots (i.e., available slot) having L available symbols for PUSCH transmission and 2 slots (i.e., unavailable slot) having X available symbols for PUSCH transmission. For the available slot, PUSCH repetition may be performed therein, and the available slot may be counted into the K slots, which is indicated by “√” in FIG. 1A. For the unavailable slot, PUSCH repetition may not be performed therein, but the unavailable slot may also be counted into the K slots, which is also indicated by “√” in FIG. 1A.

To improve the coverage of PUSCH, extending the number of repetitions and counting repetitions based on available UL resources are both agreed to be supported in NR R17. However, the detail design on how to count available UL resources is not clear and requires careful study considering time domain resource allocation, frequency hopping.

Furthermore, with additional enhanced repetition types, more types of repetitions are now available, how to report the UE capability on the repetitions and how to determine one or more of the repetitions types require further study considering the relationship of different types of repetitions, signaling overhead and flexibility of the utilization of different repetition types.

In Rel-15 slot aggregation, also known as PUSCH repetition Type A has been supported, where number of slot-based PUSCH repetitions is semi-statically configured. In Rel-16, the number of PUSCH repetitions can be dynamically configured with DCI.

In Rel-15/16, PUSCH repetition Type A allows a single repetition in each slot, with each repetition occupying the same symbols. In some TDD UL/DL configurations, there are a small number of contiguous UL slots in a radio frame. Multiple PUSCH repetitions don't have to be in contiguous slot, but the DL slots are counted as slots for PUSCH repetitions.

Two enhancements of PUSCH repetition Type A were agreed for Rel-17 NR coverage enhancement WI.

PUSCH Repetition Type A
Opt.1: Increasing the maximum number of repetitions up to a number to be determined during the course of the work.
Opt.2: The number of repetitions counted on the basis of available UL slots.

This disclosure provides methods to support PUSCH repetition enhancement which counts available slots and introduces extended number of repetitions, mainly on the detailed design of the repetition on available slots and how to determine the repetition types.

In an embodiment of the present disclosure, a first sub-type of PUSCH repetition Type A is proposed, which supports an extended number of repetitions. The extended number of PUSCH repetitions is greater than a number of PUSCH repetitions supported by a terminal device that is not capable of supporting the extended number of PUSCH repetitions. For example, the extended number may be up to 32. The first sub-type of PUSCH repetition Type A may be referred to as Type A1 in the context. In the example of FIG. 1A, K may have one or more candidate values, such as, 1, 2, 3, 4, 7, 8, 12 and 16. As for the first sub-type of PUSCH repetition Type A, K may have one or more candidate values larger than 16, such as, 32. In this way, PUSCH repetition can be performed by extended number of times, such that PUSCH coverage may be enlarged.

FIG. 1B is a diagram illustrating an exemplary procedure of PUSCH repetition according to another embodiment of the present disclosure.

In NR TDD and FDD network, there are UL slots with 14 UL symbols and DL slots with no UL symbols. In TDD a third type of slot is special slot, with less than 14 UL symbols, some DL symbols and symbols for DL/UL switch. Below are some examples of unavailable symbols in a slot for PUSCH transmission:
DL symbols, including semi-static flexible symbols which are later indicated as downlink by DCI format 2_0 with an SFI-index field
GAP symbols between UL and DL
invalid symbol pattern

In Rel-16 InvalidSymbolPattern is only configured for PUSCH repetition Type B. But in general, it can also be configured for a second sub-type of the PUSCH repetition Type A as discussed below with reference to FIG. 1B. The second sub-type of the PUSCH repetition Type A may be referred to as Type A2 in the context.

As described above, if one of L scheduled PUSCH symbols in a slot is unavailable, the slot is not counted for the repetition. The following is about how different types of slots are used and counted for multiple PUSCH repetitions and how unavailable symbols are used.

In the embodiment of FIG. 1B, UE can be RRC/DCI configured or predefined with a first threshold L1. L1 is a threshold for determining an available slot. The slot having L1 available symbols for PUSCH transmission may be referred to as an available slot in this embodiment. L1 may be less than or equal to L. The values of L, L1, and/or a difference between L and L1 may be configured by a network node or predetermined. The difference may be 1 or 2 symbols, or other number of symbols.

In the example of FIG. 1B, the K slots may include (K−2) available slots and 2 unavailable slots. For the unavailable slot, in this embodiment, the PUSCH repetition may not be performed therein, and the unavailable slot may not be counted into the K slots, which is indicated by “X” in FIG. 1B. Therefore, the PUSCH repetition ends at slot (n+K+1). With this configuration, the PUSCH repetitions are performed through K available slots (K+2 slots in the example of FIG. 1B), and thus the actual number of PUSCH repetitions is K.

As shown in FIG. 1B, the PUSCH transmission starts from slot n. If only some of the L scheduled symbols are available in a slot, such as slot (n+1) or slot (n+2), though the slot is not counted, whether the UL symbols in the slot can be used or not can be configured or fixed in specification.

Specifically, UE can be RRC/DCI configured or predefined with a second threshold X1. X1 is the required minimum number of contiguous UL symbols among the L1 scheduled symbols in a slot which can be used for PUSCH repetition. A slot with less than X1 UL symbols is not used. If X1=1, all UL symbols in the slot can be used. If X1=L1, the slots with less than L1 symbols are not used. If X1 is not configured, a default value can be predetermined, for example X1=L1.

If UE is configured to use the less than L1 UL symbols in a slot, one or more of below solutions can be adopted.

In a particular slot being unavailable slot and having X larger than or equal to X1, the X symbols available for the PUSCH transmission may be repeated as the corresponding X symbols among the L scheduled symbols in a designated available slot. In this way, the PUSCH transmission is composed of at least L*K UL symbols.

In an example, the designated available slot is one of: a previous available slot, a subsequent available slot, and an available slot at a predetermined position. Specifically, the UL symbols in the particular slot are symbol-wise repetition of the same symbols from a previous or a subsequent or a particular L1-symbol repetition, e.g., the first PUSCH repetition. A redundancy version (RV) of the particular slot is the same as the designated available slot. In the example of FIG. 1B, the RV number of slot (n+1) may be the same as the RV number of slot n or slot (n+3). And the RV number of slot (n+2) may be the same as the RV number of slot n or slot (n+3).

In another example, the PUSCH transmission in the particular slot is counted for RV cycling, and the designated available slot is an available slot having a same RV number as the particular slot. Specifically, the UL symbols in the slot are segmentation of the same symbols from a L1-symbol repetition in a slot. The transmission in the slot can be counted for RV cycling. In the example of FIG. 1B, if the RV cycling has M numbers in total, the RV number of slot (n+1) may be the same as the RV number of slot (n+1+M), such that slot (n+1+M) may be the designated available slot. And the RV number of slot (n+2) may be the same as the RV number of slot (n+2+M), such that slot (n+2+M) may be the designated available slot.

In the embodiment of FIG. 1B, a demodulation reference signal (DMRS) placement is determined based at least in part on a number of contiguous symbols available for PUSCH transmission among the L scheduled symbols in a slot; or the DMRS placement is configured by a network node.

As mentioned above, the value of X1 can be configured by RRC or DCI field. For example, if the PUSCH transmission is scheduled by dynamic grant and UE uses default PUSCH TDRA table A, X1 can be configured by new DCI field, e.g.: Minimum Available symbols in one slot. If the PUSCH transmission is scheduled by dynamic grant, X1 can be configured by RRC or DCI field. Below shows the X1 configured by RRC.

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| MinimumAvailableSymbolsinOneSlot | INTEGER(1..14) |

OPTIONAL, -- Need S

| | |
|---|---|
| PUSCH-ConfigCommon ::= | SEQUENCE { |
| groupHoppingEnabledTransformPrecoding | ENUMERATED {enabled} |

OPTIONAL, -- Need R

| | |
|---|---|
| pusch-TimeDomainAllocationList | PUSCH-TimeDomainResourceAllocationList |

OPTIONAL, -- Need R

| | |
|---|---|
| msg3-DeltaPreamble | INTEGER (−1..6) |

OPTIONAL, -- Need R

| | |
|---|---|
| p0-NominalWithGrant | INTEGER (−202..24) |

OPTIONAL, -- Need R

| | |
|---|---|
| MinimumAvailableSymbolsinOneSlot | INTEGER(1..14) |

OPTIONAL, -- Need S
}

This method guarantees the number of PUSCH repetition is K.

In an embodiment of the present disclosure, UE can be RRC/DCI configured or pre-determined whether the semi-static flexible symbols are available for PUSCH transmission with one or more of below methods, regarding dynamic SFI and invalid symbol pattern:
if dynamic SFI is not configured,
   for PUSCH repetition with dynamic grant, semi-static flexible symbols are available; for PUSCH repetition with configured grant, the availability of semi-static flexible symbols can be configured or pre-determined.
if dynamic SFI is configured,
   dynamic DL symbols are unavailable; UE can be DCI configured or pre-determined whether the dynamic flexible symbols are available for PUSCH transmission.
   for configured grant PUSCH, if at least one scheduled symbol in a slot is indicated as DL by dynamic SFI, the slot is regarded as unavailable and not counted for repetition; UE can utilize the X (X>X1) available symbols in an unavailable slot, or omit the transmission in dynamic DL symbols in the slot, or omit transmission in the slot.

In an embodiment of the present disclosure, RV cycling is done in one or more of below methods:
the available slots are counted for RV cycling.
the unavailable slots can be configured or predetermined to be counted for RV cycling or not.

In NR Rel-15/16, frequency hopping has been supported for PUSCH repetition Type A, including one or more of below options.
intra-slot frequency hopping;
inter-slot frequency hopping.

In an embodiment of the present disclosure, if frequency hopping applies for PUSCH transmission in the unavailable slot can be configured or predefined.

For example, PUSCH transmission in a slot with at least a minimum number of OFDM symbols is allowed for frequency hopping. It is to avoid a hop with too short length. In an example, the UE may receive a third threshold X2 from a network node. In a slot having X larger than or equal to X2, frequency hopping in the slot is allowed.

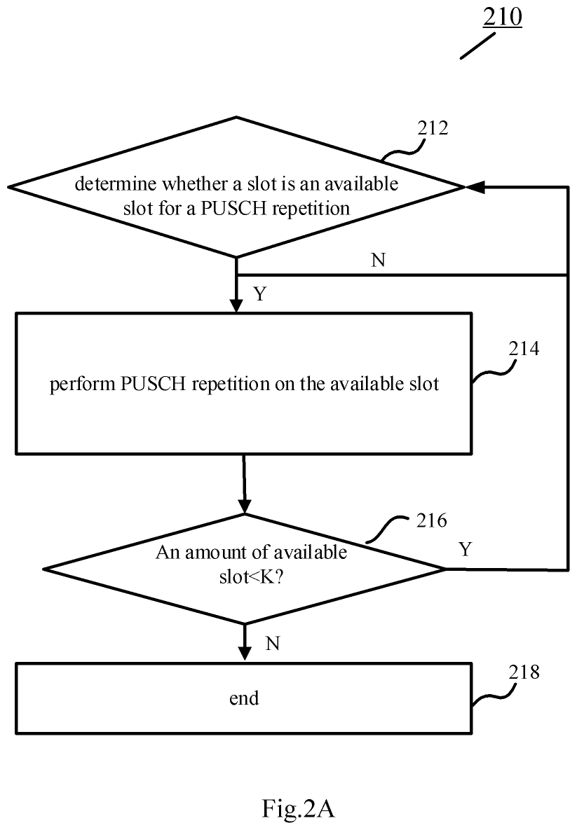

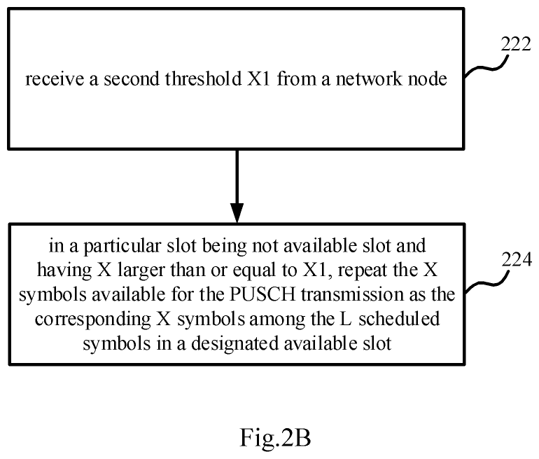

FIG. 2A is a flowchart illustrating a method according to some embodiments of the present disclosure. The method 210 illustrated in FIG. 2A may be performed by a terminal device or an apparatus communicatively coupled to the terminal device. In accordance with an exemplary embodiment, the terminal device such as a UE may be configurable to connect to a network node such as a gNB, for example, by performing PUSCH repetition.

According to the exemplary method 210 illustrated in FIG. 2A, the terminal device may determine whether a slot is an available slot for a physical uplink shared channel (PUSCH) repetition based at least in part on an amount X of symbols available for PUSCH transmission among L scheduled symbols for the PUSCH transmission in the slot, as shown in block 212. Here, a slot may be determined as an available slot in response to X being equal to L.

If the slot is an available slot (“Y” at block 212), the terminal device may perform PUSCH repetition in that slot at block 214. If the slot is not an available slot (“N” at block 212), the process goes back to block 212.

If the amount of available slots reaches K (“N” at block 216), wherein K is a number of repetitions, the process ends at block 218. If the amount of available slots is less than K (“Y” at block 216), the process goes back to block 212.

In this way, the terminal device may perform PUSCH repetitions through K available slots.

In the example of FIG. 1B, a value of K depends on a first type of the PUSCH repetition. The first type of the PUSCH repetition may be referred to as Type A2 in the context. The terminal device may report its capability of supporting the first type of the PUSCH repetition. If the terminal device supports the first type of the PUSCH repetition, the network node may configure the terminal device with the first type of the PUSCH repetition. In addition, if the terminal device supports other PUSCH repetition types, the network node may configure the terminal device with one or more of the other PUSCH repetition types.

Specifically, the terminal device may receive configuration information about one or more PUSCH repetition types from a network node, wherein the one or more PUSCH repetition types include the first type of the PUSCH repetition, and each of the one or more PUSCH repetition types supports at least one candidate value of K.

The terminal device may determine K and which of the one or more PUSCH repetition type is to be used by the terminal device, based at least in part on RRC signaling, DCI signaling and/or a time domain resource assignment (TDRA) table, wherein the TDRA table is a default table or signaled from a network node.

In an embodiment, the first type of the PUSCH repetition and a different type of the one or more PUSCH repetition type which is determined based at least in part on the TDRA tables correspond to separate TDRA tables.

In an embodiment, the first type of the PUSCH repetition and a different type of the one or more PUSCH repetition type which is determined based at least in part on the TDRA tables correspond to a same TDRA table.

In an embodiment, the first type of the PUSCH repetition may support extended number of PUSCH repetitions.

In an embodiment, the terminal device may transmit to a network node a report on whether the terminal device is capable of supporting extended number of PUSCH repetitions.

In an embodiment, the one or more PUSCH repetition types includes one or more of: the first type of the PUSCH repetition, a PUSCH repetition type A which supports up to 16 repetitions, a PUSCH repetition type A which supports an extended number of PUSCH repetitions, and a PUSCH repetition type B, wherein the one or more PUSCH repetition types are configured by an RRC message.

In an embodiment, the one or more PUSCH repetition types includes: the first type of the PUSCH repetition, and the PUSCH repetition type A which supports an extended number of PUSCH repetitions, and wherein which of the configured types is to be used by the terminal device is indicated by RRC signaling, DCI signaling and/or a TDRA table.

FIG. 2B is a flowchart illustrating a further step of the method as shown in FIG. 2A according to some embodiments of the present disclosure.

At block 222, the terminal device may receive a second threshold X1 from a network node. And then, in block 224, in a particular slot being not available slot and having X larger than or equal to X1, the terminal device may repeat the X symbols available for the PUSCH transmission as the corresponding X symbols among the L scheduled symbols in a designated available slot. For example, in the example of FIG. 1B, slot (n+1) is an unavailable slot with X available symbols at the end of the slot (n+1). If X of slot (n+1) is larger than or equal to X1, and the designated available slot is slot n, then the X available symbols in slot (n+1) are repeated as the last X symbols in the slot n.

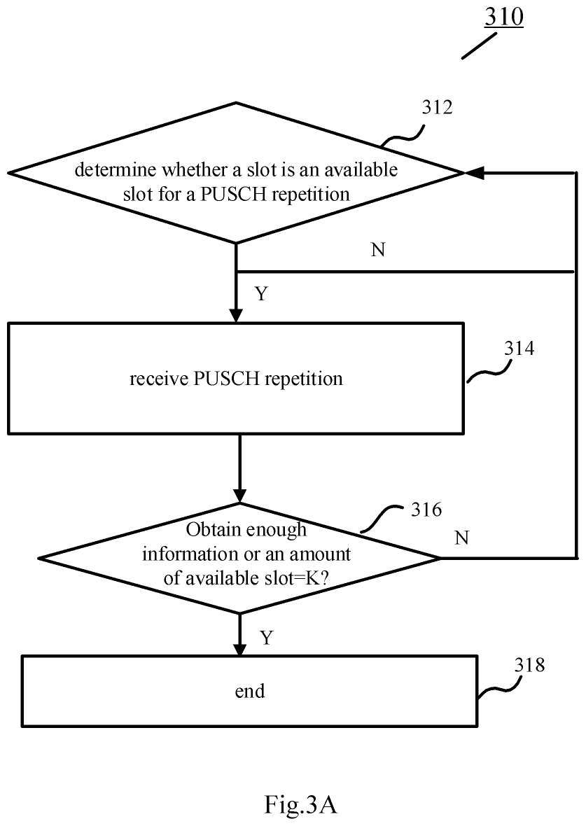

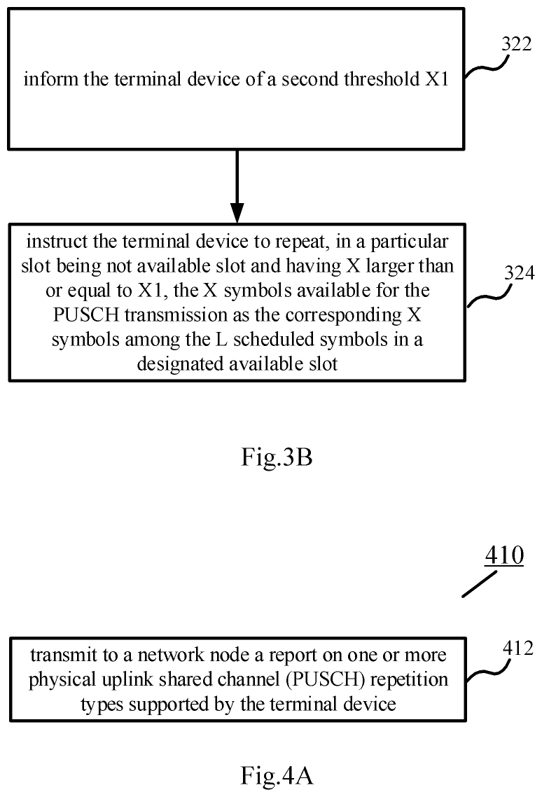

FIG. 3A is a flowchart illustrating another method according to some embodiments of the present disclosure. The method 310 illustrated in FIG. 3A may be performed by a network node or an apparatus communicatively coupled to the network node. In accordance with an exemplary embodiment, the network node such as a gNB may be configurable to connect to a terminal device such as an UE, for example, by performing PUSCH repetition.

According to the exemplary method 310 illustrated in FIG. 3A, the network node may determine whether a slot is an available slot for a PUSCH repetition based at least in part on an amount X of symbols available for PUSCH transmission among L scheduled symbols for the PUSCH transmission in the slot, as shown in block 312. Here, a slot may be determined as an available slot in response to X being equal to L.

If the slot is an available slot (“Y” at block 312), the network node may receive PUSCH repetition in that slot at block 314. If the slot is not an available slot (“N” at block 212), the process goes back to block 312.

If the network node obtains enough information from the received PUSCH repetition, or the amount of available slots reaches K (“Y” at block 316), wherein K is a number of repetitions, the process ends at block 318. Otherwise (“N” at block 316), the process goes back to block 312.

In this way, the network node may receive PUSCH repetitions through equal to or less than K available slots.

FIG. 3B is a flowchart illustrating a further step of the method as shown in FIG. 3A according to some embodiments of the present disclosure.

At block 322, the network node may inform the terminal device of a second threshold X1. And then, in block 324, the network node may instruct the terminal device to repeat, in a particular slot being not available slot and having X larger than or equal to X1, the X symbols available for the PUSCH transmission as the corresponding X symbols among the L scheduled symbols in a designated available slot.

The following is about how different types of repetitions for PUSCH are determined.

In NR R15 and R16, PUSCH repetition Type A supports at most 16 repetitions. Rel-16 additionally supports PUSCH repetition Type B. One of the two types is configured by RRC pusch-RepTypelndicatorForDCI-Format0-1-r16 or pusch-RepTypeIndicatorForDCI-Format0-2-r16.

Both increasing maximum number of repetitions (a first sub-type of Type A, referred to as type A1 below) or repetition based on available slots are possible enhancements (a second sub-type of Type A, referred to as type A2 below) for NR release 17. Therefore, there will be following specific types of repetitions for PUSCH.
PUSCH repetition Type A:
   Type A0, R15/R16 PUSCH repetition Type A with maximum number of 16;
   Type A1, PUSCH repetition Type A with increased maximum number;
   Type A2, the number of repetitions counted on the basis of available slots.
PUSCH repetition Type B

For the different types of PUSCH repetitions, in order to let the network to know which repetition types to schedule for one UE, UE repetition type capability reporting is needed for some or all the repetition types depending on the relationship between these repetition types.

FIG. 4A is a flowchart illustrating still another method according to some embodiments of the present disclosure. The method 410 illustrated in FIG. 4A may be performed by a terminal device or an apparatus communicatively coupled to the terminal device. In accordance with an exemplary embodiment, the terminal device such as a UE may be configurable to connect to a network node such as a gNB, for example, by performing PUSCH repetition.

According to the exemplary method 410 illustrated in FIG. 4A, the terminal device may transmit to a network node a report on one or more PUSCH repetition types supported by the terminal device, as shown in block 412.

The one or more PUSCH repetition types includes one or more of: a PUSCH repetition type A, a PUSCH repetition type A which supports up to 16 repetitions, a PUSCH repetition type A which supports extended number of PUSCH repetitions, and a PUSCH repetition type B. The extended number of PUSCH repetitions is greater than a number of PUSCH repetitions supported by a terminal device that is not capable of supporting the extended number of PUSCH repetitions, e.g., the extended number may be up to 32, which may be the example of FIG. 1A. According to the first type, only the PUSCH transmission in an available slot is counted for PUSCH repetition, as the example of FIG. 1B.

In an embodiment of FIG. 4A, UE needs to report its capability of supporting these new PUSCH repetition types compared to R16/15 with one or more of the following ways:
Type A2 capability does not need to be separately reported, e.g., type A2 can be derived based on the UE capability on supporting type B.
Type A1 repetition capability is reported.
Whether type A1 on top of the type A2 is supported by UE can also be reported, comprising at least one of the following:
   Repetition type A2 with extended number of repetitions (extended with type A1), i.e. extending number of actual repetitions;
   Repetition type A2 with only normal number of repetitions, type A1 is not used together with A2 for same transmissions.
Both type A1 and A2 are reported separately

Rel-16 has supported dynamic configuration of PUSCH repetition number for PUSCH repetition Type A by TDRA table. The method can be reused for Type A1 and A2. Configuration of Type A1 is the same as Type A0, except that the number of repetitions in one entry of TDRA table can be larger than 16. Thus, Type A0 is regarded as a special case of Type A1 and not especially mentioned below.

If gNB has fewer flexible slots/symbols, Type A1 is more straightforward. Type A2 is more suitable for dynamic frame structure. The determination between Type A1 and A2 can be semi-static or dynamic, depending on if gNB tends to have a dynamic frame structure and it is dynamic grant or configured grant.

FIG. 5A is a flowchart illustrating yet still another method according to some embodiments of the present disclosure. The method 510 illustrated in FIG. 5A may be performed by a network node or an apparatus communicatively coupled to the network node. In accordance with an exemplary embodiment, the network node such as a gNB may be configurable to connect to a terminal device such as an UE, for example, by performing PUSCH repetition.

According to the exemplary method 510 illustrated in FIG. 5A, the network node may receive from a terminal device a report on one or more PUSCH repetition types supported by the terminal device.

The network node may configure which PUSCH repetition type is to be used with one or more of below methods.

In an example (alternative 1), gNB configures one of Type A1, A2 and Type B by RRC signaling. In this case, only one type of repetition is used.

In another example (alternative 2), gNB configures one or more of Type A1, A2 and Type B by RRC signaling. If both Type A1 and A2 are configured, Type A1 or A2 can be determined by signaling indicated in DCI and/or the indications in the RRC TDRA table.

In still another example (alternative 3), gNB configures one of Type A and Type B by RRC signaling. If Type A is configured, Type A1 or A2 can be determined by DCI and/or by the indication in TDRA table or pre-determined.

An example of pre-determined rule can be if number of repetitions is less than 16, Type A2 is used. Otherwise Type A1 is used.

All can be used for dynamic grant and configured grant Type 2. Alternative 1 and Alternative 3 with predetermined rule can be used for configured grant Type 1.

In an embodiment of the present disclosure, if both Type A1 and A2 are configured by RRC, they can use the same or separate TDRA tables.

In an embodiment of the present disclosure, if one among type A1 and A2 is to be determined by DCI, it can be determined by signaling indicated in DCI and/or the indications in the RRC TDRA table.

Below shows the RRC configuration of TDRA table. A separate IE repetitionTypeAx indicating A1 or A2 is added for each entry. DCI field Time domain resource assignment determines one entry of TDRA table.

PUSCH-Allocation-r16 ::= SEQUENCE {

| | |
|---|---|
| mappingType-r16 | ENUMERATED {typeA, typeB} |

OPTIONAL, -- Cond NotFormat01-02-Or-TypeA

| | |
|---|---|
| startSymbolAndLength-r16 | INTEGER (0..127) |

OPTIONAL, -- Cond NotFormat01-02-Or-TypeA

| | |
|---|---|
| startSymbol-r16 | INTEGER (0..13) |

OPTIONAL, -- Cond RepTypeB

| | |
|---|---|
| length-r16 | INTEGER (1..14) |

OPTIONAL, -- Cond RepTypeB

| | |
|---|---|
| numberOfRepetitions-r16 | ENUMERATED {n1, n2, n3, n4, n7, n8, |

n12, n16} OPTIONAL, -- Cond Format01-02

| | |
|---|---|
| repetitionTypeAx | ENUMERATED {typeA1, typeA2} |

...
}

TABLE
Signaling of repetition Type Ax in TDRA table.

| Row | | | | | |
|---|---|---|---|---|---|
| index | mappingType | startSymbol | length | numberOfRepetitions | repetitionTypeAx |
| 1 | Type A | 0 | 14 | 2 | typeA1 |
| 2 | Type A | 0 | 14 | 2 | typeA2 |
| 3 | Type A | 0 | 14 | 4 | typeA2 |

In an embodiment of the present disclosure, type A1 repetition and type A2 repetition cannot be supported at the same for the same transmissions. In this embodiment, the maximum number of repetitions for type A2 repetition is the same as NR R15 and NR R16, i.e., the number of repetitions will not be extended for type A2 repetition.

In an alternative embodiment of the present disclosure, the type A1 repetition and type A2 repetition can be supported at the same time on the same transmissions. As an example, the repetitions are only counted on the available slots and the number of repetitions is also extended, to be e.g., 32 repetitions, which is larger than 16.

This disclosure provides solutions to support PUSCH repetition enhancement which counts available slots and introduces extended number of repetitions.

In RAN1 #104-e meeting, regarding enhanced PUSCH repetition on the basis of available UL slots, there are agreements on the definition of available slots and if dynamic signaling is considered for determination of available slots.

Agreements:

For defining available slots: a slot is determined as unavailable if at least one of the symbols indicated by TDRA for a PUSCH in the slot overlaps with the symbol not intended for UL transmissions. FFS details.

Agreements:

Select one of the following alternatives, considering the aspect whether or not the determination of all the available slots should be done prior to the first actual transmission of the repetitions (other alternatives are not precluded):
Alt1: Whether or not a slot is determined as available for UL transmissions depends on RRC configurations (at least tdd_ul_dl configuration, FFS: other RRC configurations) and does not depend on dynamic signaling (at least SFI, FFS: other dynamic signaling e.g. CI, PUSCH priority for URLLC).
Alt2: Whether or not a slot is determined as available for UL transmissions depends on RRC configurations (at least tdd_ul_dl configuration, FFS: other RRC configurations) and also depends on dynamic signaling (at least SFI, FFS: other dynamic signaling e.g. CI, PUSCH priority for URLLC).

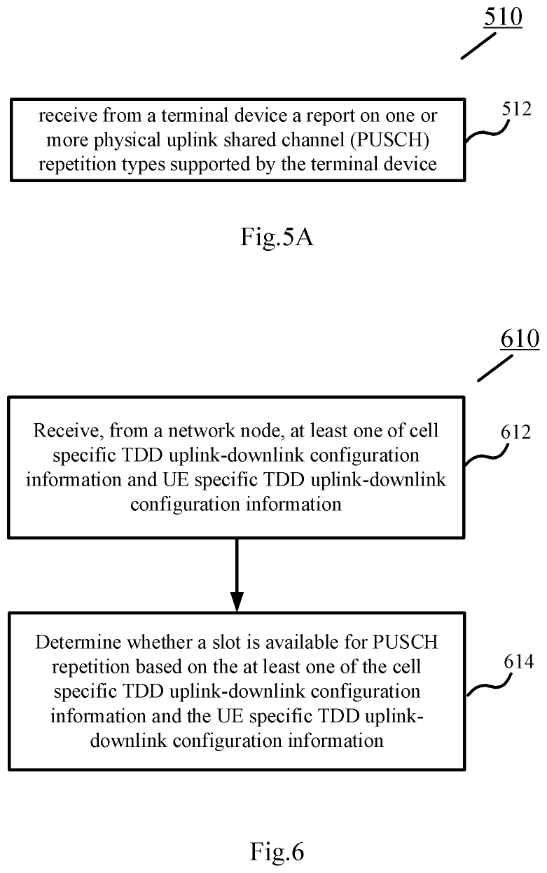

FIG. 6 is a flowchart illustrating a method 610 according to some embodiments of the present disclosure. The method 610 illustrated in FIG. 6 may be performed by a terminal device or an apparatus communicatively coupled to the terminal device. In accordance with an exemplary embodiment, the terminal device such as a UE may be configurable to connect to a network node such as a gNB.

At block 612, at least one of cell specific TDD uplink-downlink configuration information and (dedicated) UE specific TDD uplink-downlink configuration information is received from a network node.

Here, the cell specific TDD uplink-downlink configuration information may be tdd-UL-DL-ConfigurationCommon and the UE specific TDD uplink-downlink configuration information may be tdd-UL-DL-ConfigurationDedicated.

At block 614, it is determined whether a slot is available for PUSCH repetition based on the at least one of the cell specific TDD uplink-downlink configuration information and the UE specific TDD uplink-downlink configuration information.

Here, the PUSCH repetition may include a DG-PUSCH, a Type-1 CG-PUSCH, or a Type-2 CG-PUSCH.

In an example, in the block 614, the slot can be determined to be unavailable for PUSCH repetition when the slot is configured as downlink by the at least one of the cell specific TDD uplink-downlink configuration information and the UE specific TDD uplink-downlink configuration information. On the other hand, the slot may be determined to be available for PUSCH repetition when the slot is not configured as downlink by the at least one of the cell specific TDD uplink-downlink configuration information and the UE specific TDD uplink-downlink configuration information. This means, as long as the slot is a flexible or uplink slot determined by the cell-specific TDD uplink-downlink configuration and/or the UE specific TDD uplink-downlink configuration, it may be determined as an available slot which will be counted as one of candidate repetition transmission occasions among a number of repetitions indicated by a repetition factor from the network node.

As an example, for configured grant based PUSCH transmissions with repetition Type A, a slot is determined as an available slot as long as it is not configured as downlink by tdd-UL-DL-ConfigurationCommon and/or tdd-UL-DL-ConfigurationDedicated, and whether there will be actual transmission in the available slot may depend on other rules. In an example, only when symbols allocated (e.g., indicated by PUSCH TDRA) in the available slot are uplink symbols, the actual transmission may be allowed in that slot, otherwise the transmission on that slot will be discarded though the slot is counted as one available slot.

In another example, in the block 614, the slot can be determined to be available for PUSCH repetition when the slot includes no symbol that is configured as downlink by the at least one of the cell specific TDD uplink-downlink configuration information and the UE specific TDD uplink-downlink configuration information and overlaps any symbol in a set of symbols indicated by PUSCH TDRA.

In another example, in the block 614, the slot can be determined to be available for PUSCH repetition when the slot is configured as uplink by the at least one of the cell specific TDD uplink-downlink configuration information and the UE specific TDD uplink-downlink configuration information, or includes a set of symbols, indicated by PUSCH TDRA, each configured as uplink or flexible by the at least one of the cell specific TDD uplink-downlink configuration information and the UE specific TDD uplink-downlink configuration information. For example, a slot with each symbol in the set of symbols (allocated by PUSCH TDRA for PUSCH repetition) configured as flexible, or a slot with a part of the set of symbols (allocated by PUSCH TDRA for PUSCH repetition) configured as flexible and the remaining part of the set of symbols configured as uplink, can be determined to be available for PUSCH repetition.

In an example, the terminal device may receive, from the network node, control information (e.g., DCI) indicating the at least one of the cell specific TDD uplink-downlink configuration information and the UE specific TDD uplink-downlink configuration information to be used for determining whether the slot is available for PUSCH repetition. For example, a configuration in DCI scheduling PUSCH repetition may indicate which one or both of the common (cell-specific) TDD uplink-downlink configuration information and the dedicated (UE-specific) TDD uplink-downlink configuration information are to be used for determining an available slot for PUSCH repetition. Alternatively, e.g., when no such configuration in DCI is available, the determining operation in the block 614 may be based on the cell specific TDD uplink-downlink configuration information when only the cell specific TDD uplink-downlink configuration information is received, or based on both the cell specific TDD uplink-downlink configuration information and the UE specific TDD uplink-downlink configuration information when both the cell specific TDD uplink-downlink configuration information and the UE specific TDD uplink-downlink configuration information are received.

Then, the terminal device may determine whether an actual transmission of the PUSCH repetition (e.g., an enhanced Type A PUSCH repetition) is allowed on the slot determined as available.

In an example, when at least one symbol in the set of symbols indicated by the PUSCH TDRA is configured as flexible by the at least one of the cell specific TDD uplink-downlink configuration information and the UE specific TDD uplink-downlink configuration information and no dynamic SFI for the slot is received from the network node, the terminal device can determine whether to transmit the PUSCH repetition in the slot in accordance with RRC signaling or DCI from the network node, or with a predetermined rule. For example, the terminal device may determine to transmit the PUSCH repetition (e.g., Type-1 CG-PUSCH) in the slot regardless of whether the terminal device is configured with enableConfiguredUL.

Here, a collision may happen between a determined available slot for PUSCH repetition and a dynamic SFI. For example, for Type-1 CG-PUSCH repetition, a dynamic SFI may indicate a flexible symbol as downlink or flexible.

In an example, the terminal device may identify an error case when at least one symbol in the set of symbols is configured as flexible by the at least one of the cell specific TDD uplink-downlink configuration information and the UE specific TDD uplink-downlink configuration information and indicated as downlink or flexible in a dynamic SFI for the slot as received from the network node (i.e., the terminal device does not expect this case). That is, the dynamic SFI may only indicate the flexible symbol(s) as uplink.

In another example, the terminal device may identify an error case when at least one symbol in the set of symbols is configured as flexible by the at least one of the cell specific TDD uplink-downlink configuration information and the UE specific TDD uplink-downlink configuration information and indicated as downlink in a dynamic SFI for the slot as received from the network node (i.e., the terminal device does not expect this case). That is, the dynamic SFI may indicate the flexible symbol(s) as flexible or uplink.

In an example, when each symbol in the set of symbols that is configured as flexible by the at least one of the cell specific TDD uplink-downlink configuration information and the UE specific TDD uplink-downlink configuration information is indicated as uplink in a dynamic SFI for the slot as received from the network node, the terminal device can transmit the PUSCH repetition in the slot.

In another example, when a subset of the set of symbols is indicated as downlink or flexible in a dynamic SFI for the slot as received from the network node, the terminal device can transmit the PUSCH repetition in symbols in the subset that are earlier than a timer (e.g., PUSCH preparation timer) after a last symbol of a PDCCH in which the dynamic SFI is received, and cancel the PUSCH repetition in remaining symbols in the subset.

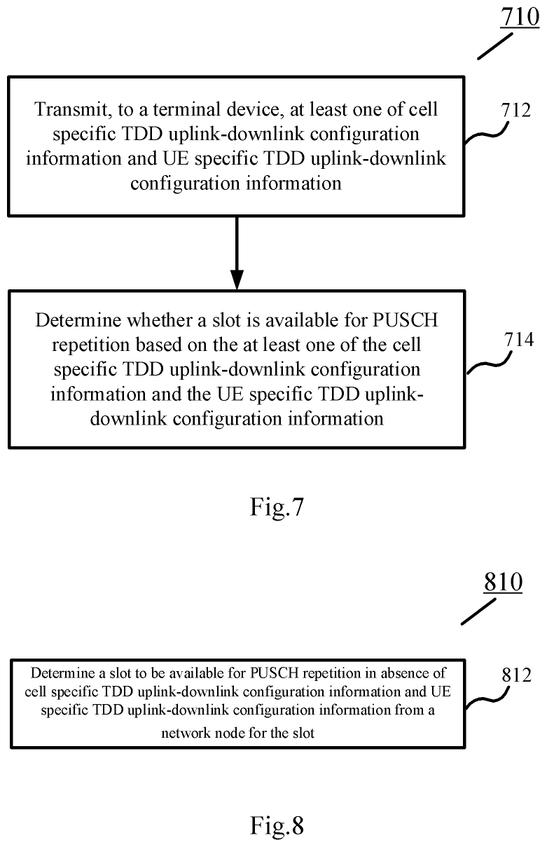

FIG. 7 is a flowchart illustrating another method 710 according to some embodiments of the present disclosure. The method 710 illustrated in FIG. 7 may be performed by a network node or an apparatus communicatively coupled to the network node. In accordance with an exemplary embodiment, the network node such as a gNB may be configurable to connect to a terminal device such as an UE.

At block 712, at least one of cell specific TDD uplink-downlink configuration information and (dedicated) UE specific TDD uplink-downlink configuration information is transmitted to a terminal device.

Here, the cell specific TDD uplink-downlink configuration information may be tdd-UL-DL-ConfigurationCommon and the UE specific TDD uplink-downlink configuration information may be tdd-UL-DL-ConfigurationDedicated.

At block 714, it is determined whether a slot is available for PUSCH repetition based on the at least one of the cell specific TDD uplink-downlink configuration information and the UE specific TDD uplink-downlink configuration information.

Here, the PUSCH repetition may include a DG-PUSCH, a Type-1 CG-PUSCH, or a Type-2 CG-PUSCH.

In an example, in the block 714, the slot can be determined to be unavailable for PUSCH repetition when the slot is configured as downlink by the at least one of the cell specific TDD uplink-downlink configuration information and the UE specific TDD uplink-downlink configuration information.

In another example, in the block 714, the slot can be determined to be available for PUSCH repetition when the slot includes no symbol that is configured as downlink by the at least one of the cell specific TDD uplink-downlink configuration information and the UE specific TDD uplink-downlink configuration information and overlaps any symbol in a set of symbols indicated by PUSCH TDRA.

In another example, in the block 714, the slot can be determined to be available for PUSCH repetition when the slot is configured as uplink by the at least one of the cell specific TDD uplink-downlink configuration information and the UE specific TDD uplink-downlink configuration information, or includes a set of symbols, indicated by PUSCH TDRA, each configured as uplink or flexible by the at least one of the cell specific TDD uplink-downlink configuration information and the UE specific TDD uplink-downlink configuration information.

In an example, the network node can transmit, to the terminal device, control information (e.g., DCI) indicating the at least one of the cell specific TDD uplink-downlink configuration information and the UE specific TDD uplink-downlink configuration information to be used for determining whether the slot is available for PUSCH repetition. For example, a configuration in DCI scheduling PUSCH repetition may indicate which one or both of the common (cell-specific) TDD uplink-downlink configuration information and the dedicated (UE-specific) TDD uplink-downlink configuration information are to be used for determining an available slot for PUSCH repetition.

Then, the network node may determine whether an actual transmission of the PUSCH repetition (e.g., an enhanced Type A PUSCH repetition) will occur, and accordingly whether to receive the PUSCH repetition, in the slot determined as available.

In an example, when at least one symbol in the set of symbols is configured as flexible by the at least one of the cell specific TDD uplink-downlink configuration information and the UE specific TDD uplink-downlink configuration information and no SFI for the slot is transmitted to the terminal device, the network node can transmit, to the terminal device, RRC signaling or DCI indicating whether the terminal device is to transmit the PUSCH repetition in the slot, or determine whether to receive the PUSCH repetition in the slot in accordance with a predetermined rule. For example, the network node may determine to receive the PUSCH repetition in the slot regardless of whether the terminal device is configured with enableConfiguredUL.

In another example, the network node can transmit, to the terminal device, a dynamic SFI for the slot, the dynamic SFI indicating each symbol in the set of symbols that is configured as flexible by the at least one of the cell specific TDD uplink-downlink configuration information and the UE specific TDD uplink-downlink configuration information as uplink, and receive the PUSCH repetition in the slot.

In another example, the network node can transmitting, to the terminal device, a dynamic SFI for the slot, the dynamic SFI indicating a subset of the set of symbols as downlink or flexible, and receive the PUSCH repetition in symbols in the subset that are earlier than a timer (e.g., PUSCH preparation timer) after a last symbol of a PDCCH in which the dynamic SFI is transmitted, but not in remaining symbols in the subset.

The method 710 performed by the network node corresponds to the method 610 performed by the terminal device as described above in connection with FIG. 6. Thus, the above detailed description of the method 610 also applies to the method 710.

FIG. 8 is a flowchart illustrating a method 810 according to some embodiments of the present disclosure. The method 810 illustrated in FIG. 8 may be performed by a terminal device or an apparatus communicatively coupled to the terminal device. In accordance with an exemplary embodiment, the terminal device such as a UE may be configurable to connect to a network node such as a gNB.

At block 812, a slot is determined to be available for PUSCH repetition in absence of cell specific TDD, uplink-downlink configuration information and (dedicated) UE specific TDD uplink-downlink configuration information from a network node for the slot.

Here, the cell specific TDD uplink-downlink configuration information may be tdd-UL-DL-ConfigurationCommon and the UE specific TDD uplink-downlink configuration information may be tdd-UL-DL-ConfigurationDedicated. The PUSCH repetition may include a DG-PUSCH, a Type-1 CG-PUSCH, or a Type-2 CG-PUSCH.

Then, the terminal device may determine whether an actual transmission of the PUSCH repetition (e.g., an enhanced Type A PUSCH repetition) is allowed on the slot determined as available.

In an example, when no dynamic SFI for the slot is received from the network node, the terminal device can determine whether to transmit the PUSCH repetition in the slot in accordance with RRC signaling or DCI from the network node, or with a predetermined rule. For example, the terminal device may determine to transmit the PUSCH repetition in the slot regardless of whether the terminal device is configured with enableConfiguredUL.

In an example, the terminal device may identify an error case when at least one symbol in a set of symbols indicated by PUSCH TDRA is indicated as downlink or flexible in a dynamic SFI for the slot as received from the network node (i.e., the terminal device does not expect this case). That is, the dynamic SFI may only indicate the flexible symbol(s) as uplink.

In an example, the terminal device may identify an error case when at least one symbol in a set of symbols indicated by PUSCH TDRA is indicated as downlink in a dynamic SFI for the slot as received from the network node (i.e., the terminal device does not expect this case). That is, the dynamic SFI may indicate the flexible symbol(s) as flexible or uplink.

In another example, the terminal device may transmit the PUSCH repetition in the slot when each symbol in a set of symbols indicated by PUSCH TDRA is indicated as uplink in a dynamic SFI for the slot as received from the network node.

In another example, when a subset of a set of symbols indicated by PUSCH TDRA is indicated as downlink or flexible in a dynamic SFI for the slot as received from the network node, the terminal device may transmit the PUSCH repetition in symbols in the subset that are earlier than a timer (e.g., PUSCH preparation timer) after a last symbol of a PDCCH in which the dynamic SFI is received, and cancel the PUSCH repetition in remaining symbols in the subset.

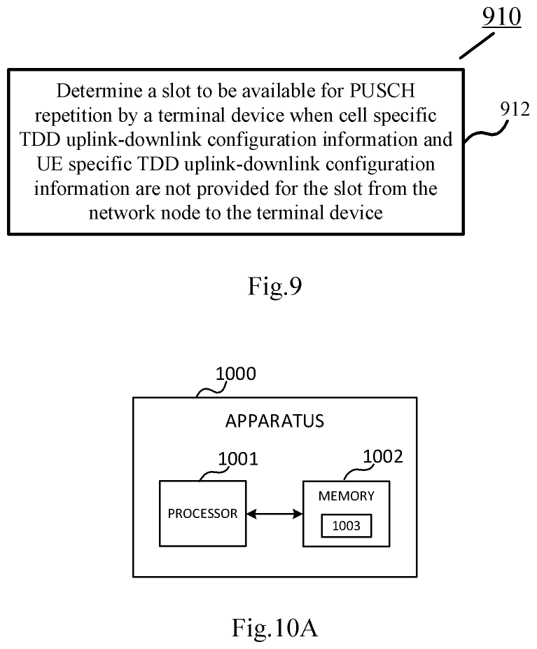

FIG. 9 is a flowchart illustrating another method 910 according to some embodiments of the present disclosure. The method 910 illustrated in FIG. 9 may be performed by a network node or an apparatus communicatively coupled to the network node. In accordance with an exemplary embodiment, the network node such as a gNB may be configurable to connect to a terminal device such as an UE.

At block 912, a slot is determined to be available for PUSCH repetition by a terminal device when cell specific TDD uplink-downlink configuration information and (dedicated) UE specific TDD uplink-downlink configuration information are not provided for the slot from the network node to the terminal device.

Here, the cell specific TDD uplink-downlink configuration information may be tdd-UL-DL-ConfigurationCommon and the UE specific TDD uplink-downlink configuration information may be tdd-UL-DL-ConfigurationDedicated. The PUSCH repetition may include a DG-PUSCH, a Type-1 CG-PUSCH, or a Type-2 CG-PUSCH.

Then, the network node may determine whether an actual transmission of the PUSCH repetition (e.g., an enhanced Type A PUSCH repetition) will occur, and accordingly whether to receive the PUSCH repetition, in the slot determined as available.

In an example, when no dynamic SFI for the slot is transmitted to the terminal device, the network node may transmit, to the terminal device, RRC signaling or DCI indicating whether the terminal device is to transmit the PUSCH repetition in the slot, or determine whether to receive the PUSCH repetition in the slot in accordance with a predetermined rule. For example, the network node may determine to receive the PUSCH repetition in the slot regardless of whether the terminal device is configured with enableConfiguredUL.

In another example, the network node may transmit, to the terminal device, a dynamic SFI for the slot, the dynamic SFI indicating each symbol in a set of symbols indicated by PUSCH TDRA is indicated as uplink, and receive the PUSCH repetition in the slot.

In another example, the network node may transmit, to the terminal device, a dynamic SFI for the slot, the dynamic SFI indicating a subset of the set of symbols as downlink or flexible, and receiving the PUSCH repetition in symbols in the subset that are earlier than a timer (e.g., PUSCH preparation timer) after a last symbol of a PDCCH in which the dynamic SFI is transmitted, but not in remaining symbols in the subset.

The method 910 performed by the network node corresponds to the method 810 performed by the terminal device as described above in connection with FIG. 8. Thus, the above detailed description of the method 810 also applies to the method 910.

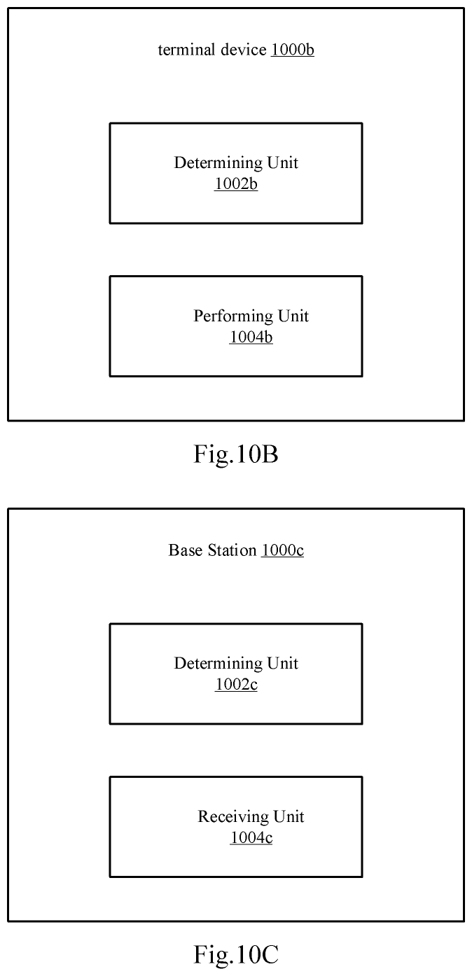

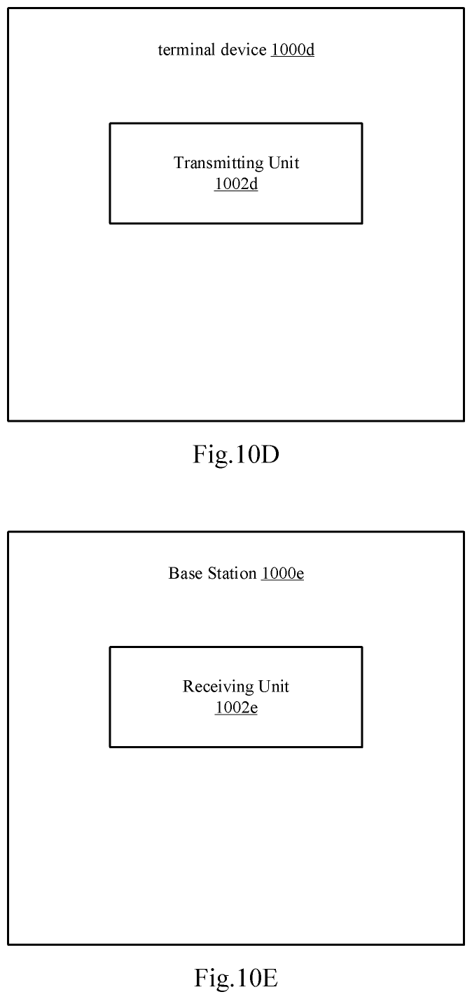

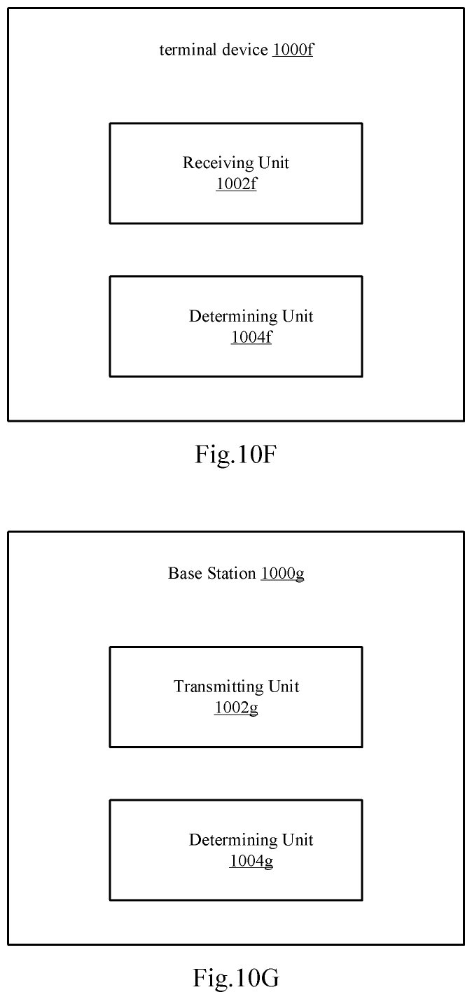

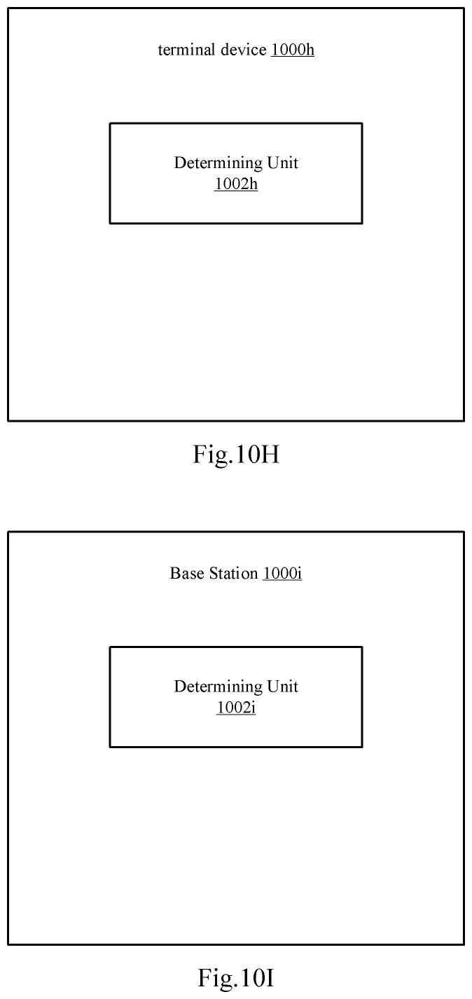

FIG. 10A is a block diagram illustrating an apparatus 1000 according to various embodiments of the present disclosure. As shown in FIG. 10A, the apparatus 1000 may comprise one or more processors such as processor 1001 and one or more memories such as memory 1002 storing computer program codes 1003. The memory 1002 may be non-transitory machine/processor/computer readable storage medium. In accordance with some exemplary embodiments, the apparatus 1000 may be implemented as an integrated circuit chip or module that can be plugged or installed into a terminal device as described with respect to FIG. 2A, FIG. 4A, FIG. 6, or FIG. 8, or a network node as described with respect to FIG. 3A, FIG. 5A, FIG. 7, or FIG. 9. In such case, the apparatus 1000 may be implemented as a terminal device as described with respect to FIG. 2A, FIG. 4A, FIG. 6, or FIG. 8, or a network node as described with respect to FIG. 3A, FIG. 5A, FIG. 7, or FIG. 9.

In some implementations, the one or more memories 1002 and the computer program codes 1003 may be configured to, with the one or more processors 1001, cause the apparatus 1000 at least to perform any operation of the method as described in connection with FIG. 2A, FIG. 4A, FIG. 6, or FIG. 8. In other implementations, the one or more memories 1002 and the computer program codes 1003 may be configured to, with the one or more processors 1001, cause the apparatus 1000 at least to perform any operation of the method as described in connection with FIG. 3A, FIG. 5A, FIG. 7, or FIG. 9. Alternatively or additionally, the one or more memories 1002 and the computer program codes 1003 may be configured to, with the one or more processors 1001, cause the apparatus 1000 at least to perform more or less operations to implement the proposed methods according to the exemplary embodiments of the present disclosure.

Various embodiments of the present disclosure provide an apparatus for PUSCH repetition. In an exemplary embodiment, the apparatus may be implemented in a terminal device such as a UE. FIG. 10B, FIG. 10D, FIG. 10F, and FIG. 10H each illustrate a block diagram showing a terminal device according to an embodiment of the disclosure. As shown in FIG. 10B, the terminal device 1000b comprises a determining unit 1002b and a performing unit 1004b. The determining unit 1002b may be operable to carry out the operation in block 212, and the performing unit 1004b may be operable to carry out the operation in block 214. Optionally, the performing unit 1004b and/or the determining unit 1002b may be operable to carry out more or less operations to implement the proposed methods according to the exemplary embodiments of the present disclosure.

As shown in FIG. 10D, the terminal device 1000d comprises a transmitting unit 1002d. The transmitting unit 1002d may be operable to carry out the operation in block 412. Optionally, the transmitting unit 1002d may be operable to carry out more or less operations to implement the proposed methods according to the exemplary embodiments of the present disclosure.

As shown in FIG. 10F, the terminal device 1000f comprises a receiving unit 1002f and a determining unit 1004f. The receiving unit 1002f may be operable to carry out the operation in block 612, and the determining unit 1004f may be operable to carry out the operation in block 614. Optionally, the receiving unit 1002f and the determining unit 1004f may be operable to carry out more or less operations to implement the proposed methods according to the exemplary embodiments of the present disclosure.

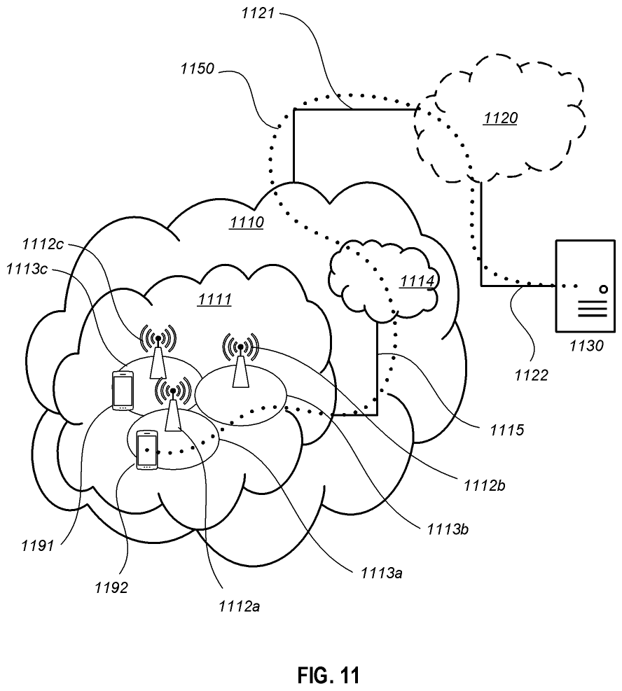

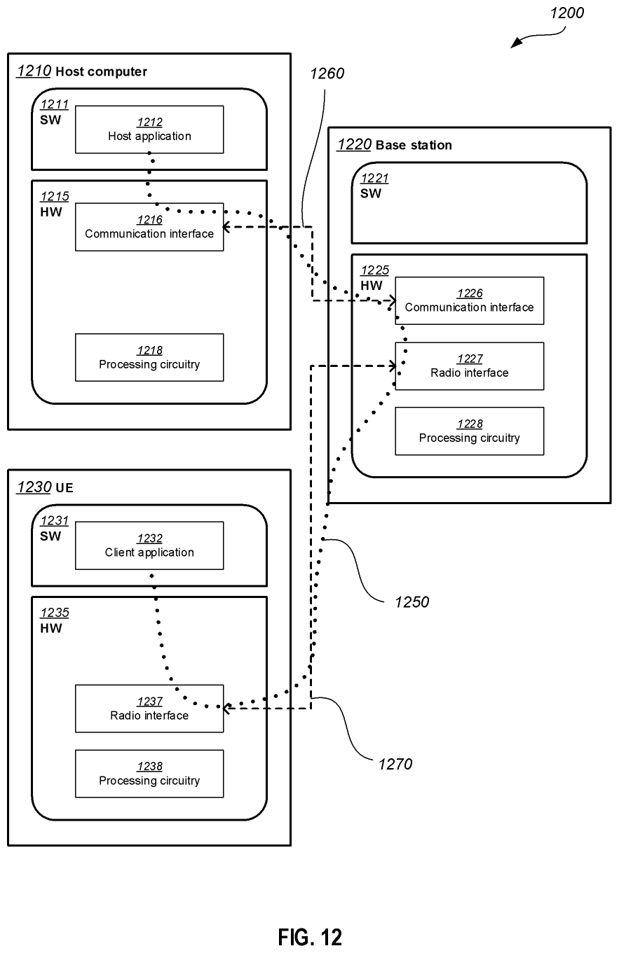

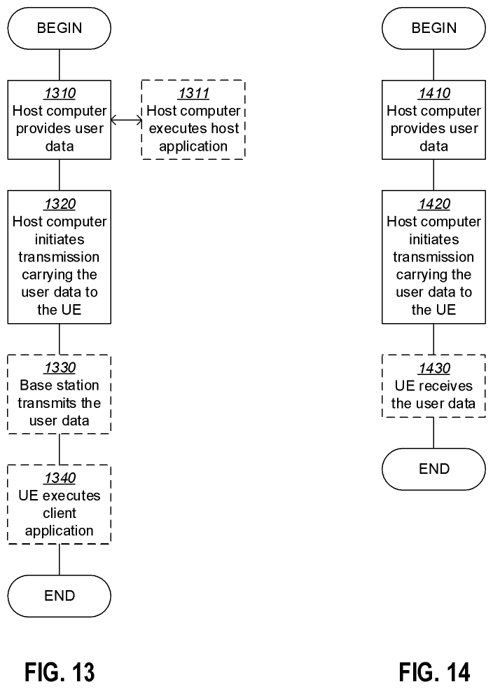

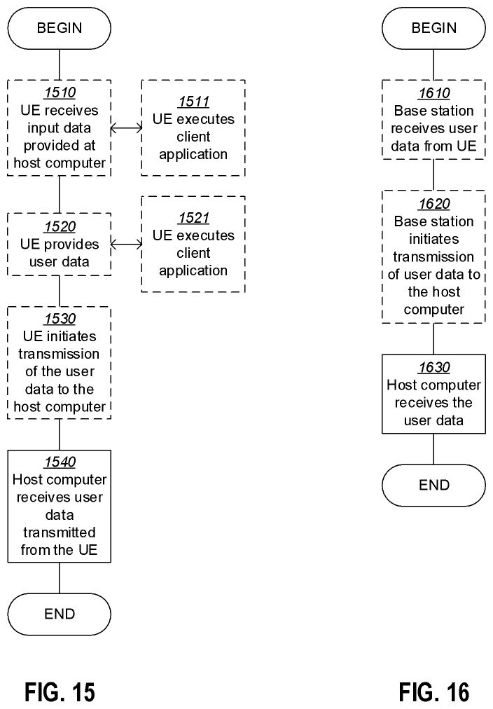

As shown in FIG. 101H, the terminal device 1000h comprises a determining unit 1002h. The determining unit 1002h may be operable to carry out the operation in block 812. Optionally, the determining unit 1002h may be operable to carry out more or less operations to implement the proposed methods according to the exemplary embodiments of the present disclosure.

Various embodiments of the present disclosure provide an apparatus for PUSCH repetition. In an exemplary embodiment, the apparatus may be implemented in a network node such as a base station. FIG. 10C, FIG. 10E, FIG. 10G, and FIG. 101 each illustrate a block diagram showing a base station according to an embodiment of the disclosure. As shown in FIG. 10C, the base station 1000c comprises a determining unit 1002c and a receiving unit 1004c. The determining unit 1002c may be operable to carry out the operation in block 312, and the receiving unit 1004c may be operable to carry out the operation in block 314. Optionally, the determining unit 1002c and/or the receiving unit 1004c may be operable to carry out more or less operations to implement the proposed methods according to the exemplary embodiments of the present disclosure.

As shown in FIG. 10E, the base station 1000e comprises a receiving unit 1002e. The receiving unit 1002e may be operable to carry out the operation in block 512. Optionally, the receiving unit 1002e may be operable to carry out more or less operations to implement the proposed methods according to the exemplary embodiments of the present disclosure.

As shown in FIG. 10G, the base station 1000g comprises a transmitting unit 1002g and a determining unit 1004g. The transmitting unit 1002g may be operable to carry out the operation in block 712, and the determining unit 1004g may be operable to carry out the operation in block 714. Optionally, the transmitting unit 1002g and the determining unit 1004g may be operable to carry out more or less operations to implement the proposed methods according to the exemplary embodiments of the present disclosure.

As shown in FIG. 101, the base station 1000i comprises a determining unit 1002i. The determining unit 1002i may be operable to carry out the operation in block 912. Optionally, the determining unit 1002i may be operable to carry out more or less operations to implement the proposed methods according to the exemplary embodiments of the present disclosure.

FIG. 11 is a block diagram illustrating a telecommunication network connected via an intermediate network to a host computer in accordance with some embodiments of the present disclosure.

With reference to FIG. 11, in accordance with an embodiment, a communication system includes a telecommunication network 1110, such as a 3GPP-type cellular network, which comprises an access network 1111, such as a radio access network, and a core network 1114. The access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to the core network 1114 over a wired or wireless connection 1115. A first UE 1191 located in a coverage area 1113c is configured to wirelessly connect to, or be paged by, the corresponding base station 1112c. A second UE 1192 in a coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

The telecommunication network 1110 is itself connected to a host computer 1130, which may be embodied in the hardware and/or software of a standalone server, a cloud-implemented server, a distributed server or as processing resources in a server farm. The host computer 1130 may be under the ownership or control of a service provider, or may be operated by the service provider or on behalf of the service provider. Connections 1121 and 1122 between the telecommunication network 1110 and the host computer 1130 may extend directly from the core network 1114 to the host computer 1130 or may go via an optional intermediate network 1120. An intermediate network 1120 may be one of, or a combination of more than one of, a public, private or hosted network; the intermediate network 1120, if any, may be a backbone network or the Internet; in particular, the intermediate network 1120 may comprise two or more sub-networks (not shown).

The communication system of FIG. 11 as a whole enables connectivity between the connected UEs 1191, 1192 and the host computer 1130. The connectivity may be described as an over-the-top (OTT) connection 1150. The host computer 1130 and the connected UEs 1191, 1192 are configured to communicate data and/or signaling via the OTT connection 1150, using the access network 1111, the core network 1114, any intermediate network 1120 and possible further infrastructure (not shown) as intermediaries. The OTT connection 1150 may be transparent in the sense that the participating communication devices through which the OTT connection 1150 passes are unaware of routing of uplink and downlink communications. For example, the base station 1112 may not or need not be informed about the past routing of an incoming downlink communication with data originating from the host computer 1130 to be forwarded (e.g., handed over) to a connected UE 1191. Similarly, the base station 1112 need not be aware of the future routing of an outgoing uplink communication originating from the UE 1191 towards the host computer 1130.

FIG. 12 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 12. In a communication system 1200, a host computer 1210 comprises hardware 1215 including a communication interface 1216 configured to set up and maintain a wired or wireless connection with an interface of a different communication device of the communication system 1200. The host computer 1210 further comprises a processing circuitry 1218, which may have storage and/or processing capabilities. In particular, the processing circuitry 1218 may comprise one or more programmable processors, application-specific integrated circuits, field programmable gate arrays or combinations of these (not shown) adapted to execute instructions. The host computer 1210 further comprises software 1211, which is stored in or accessible by the host computer 1210 and executable by the processing circuitry 1218. The software 1211 includes a host application 1212. The host application 1212 may be operable to provide a service to a remote user, such as UE 1230 connecting via an OTT connection 1250 terminating at the UE 1230 and the host computer 1210. In providing the service to the remote user, the host application 1212 may provide user data which is transmitted using the OTT connection 1250.

The communication system 1200 further includes a base station 1220 provided in a telecommunication system and comprising hardware 1225 enabling it to communicate with the host computer 1210 and with the UE 1230. The hardware 1225 may include a communication interface 1226 for setting up and maintaining a wired or wireless connection with an interface of a different communication device of the communication system 1200, as well as a radio interface 1227 for setting up and maintaining at least a wireless connection 1270 with the UE 1230 located in a coverage area (not shown in FIG. 12) served by the base station 1220. The communication interface 1226 may be configured to facilitate a connection 1260 to the host computer 1210. The connection 1260 may be direct or it may pass through a core network (not shown in FIG. 12) of the telecommunication system and/or through one or more intermediate networks outside the telecommunication system. In the embodiment shown, the hardware 1225 of the base station 1220 further includes a processing circuitry 1228, which may comprise one or more programmable processors, application-specific integrated circuits, field programmable gate arrays or combinations of these (not shown) adapted to execute instructions. The base station 1220 further has software 1221 stored internally or accessible via an external connection.

The communication system 1200 further includes the UE 1230 already referred to. Its hardware 1235 may include a radio interface 1237 configured to set up and maintain a wireless connection 1270 with a base station serving a coverage area in which the UE 1230 is currently located. The hardware 1235 of the UE 1230 further includes a processing circuitry 1238, which may comprise one or more programmable processors, application-specific integrated circuits, field programmable gate arrays or combinations of these (not shown) adapted to execute instructions. The UE 1230 further comprises software 1231, which is stored in or accessible by the UE 1230 and executable by the processing circuitry 1238. The software 1231 includes a client application 1232. The client application 1232 may be operable to provide a service to a human or non-human user via the UE 1230, with the support of the host computer 1210. In the host computer 1210, an executing host application 1212 may communicate with the executing client application 1232 via the OTT connection 1250 terminating at the UE 1230 and the host computer 1210. In providing the service to the user, the client application 1232 may receive request data from the host application 1212 and provide user data in response to the request data. The OTT connection 1250 may transfer both the request data and the user data. The client application 1232 may interact with the user to generate the user data that it provides.

It is noted that the host computer 1210, the base station 1220 and the UE 1230 illustrated in FIG. 12 may be similar or identical to the host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, the OTT connection 1250 has been drawn abstractly to illustrate the communication between the host computer 1210 and the UE 1230 via the base station 1220, without explicit reference to any intermediary devices and the precise routing of messages via these devices. Network infrastructure may determine the routing, which it may be configured to hide from the UE 1230 or from the service provider operating the host computer 1210, or both. While the OTT connection 1250 is active, the network infrastructure may further take decisions by which it dynamically changes the routing (e.g., on the basis of load balancing consideration or reconfiguration of the network).

Wireless connection 1270 between the UE 1230 and the base station 1220 is in accordance with the teachings of the embodiments described throughout this disclosure. One or more of the various embodiments improve the performance of OTT services provided to the UE 1230 using the OTT connection 1250, in which the wireless connection 1270 forms the last segment. More precisely, the teachings of these embodiments may improve the latency, and thereby provide benefits such as lower complexity, reduced time required to access a cell, better responsiveness, etc.

A measurement procedure may be provided for the purpose of monitoring data rate, latency and other factors on which the one or more embodiments improve. There may further be an optional network functionality for reconfiguring the OTT connection 1250 between the host computer 1210 and the UE 1230, in response to variations in the measurement results. The measurement procedure and/or the network functionality for reconfiguring the OTT connection 1250 may be implemented in software 1211 and hardware 1215 of the host computer 1210 or in software 1231 and hardware 1235 of the UE 1230, or both. In embodiments, sensors (not shown) may be deployed in or in association with communication devices through which the OTT connection 1250 passes; the sensors may participate in the measurement procedure by supplying values of the monitored quantities exemplified above, or supplying values of other physical quantities from which the software 1211, 1231 may compute or estimate the monitored quantities. The reconfiguring of the OTT connection 1250 may include message format, retransmission settings, preferred routing etc.; the reconfiguring need not affect the base station 1220, and it may be unknown or imperceptible to the base station 1220. Such procedures and functionalities may be known and practiced in the art. In certain embodiments, measurements may involve proprietary UE signaling facilitating the host computer 1210's measurements of throughput, propagation times, latency and the like. The measurements may be implemented in that the software 1211 and 1231 causes messages to be transmitted, in particular empty or ‘dummy’ messages, using the OTT connection 1250 while it monitors propagation times, errors etc.

FIG. 13 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

FIG. 14 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 14 will be included in this section. In step 1410 of the method, the host computer provides user data. In an optional substep (not shown) the host computer provides the user data by executing a host application. In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

FIG. 15 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

FIG. 16 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 310 as describe with respect to FIG. 3A, the exemplary method 510 as describe with respect to FIG. 5A, the exemplary method 710 as describe with respect to FIG. 7, or the exemplary method 910 as describe with respect to FIG. 9.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 310 as describe with respect to FIG. 3A, the exemplary method 510 as describe with respect to FIG. 5A, the exemplary method 710 as describe with respect to FIG. 7, or the exemplary method 910 as describe with respect to FIG. 9.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 210 as describe with respect to FIG. 2A, the exemplary method 410 as describe with respect to FIG. 4A, the exemplary method 610 as describe with respect to FIG. 6, or the exemplary method 810 as describe with respect to FIG. 8.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 210 as describe with respect to FIG. 2A, the exemplary method 410 as describe with respect to FIG. 4A, the exemplary method 610 as describe with respect to FIG. 6, or the exemplary method 810 as describe with respect to FIG. 8.

According to some exemplary embodiments, there is provided a method implemented in a communication system which may include a host computer, a base station and a UE. The method may comprise, at the host computer, receiving user data transmitted to the base station from the UE which may perform any step of the exemplary method 210 as describe with respect to FIG. 2A, the exemplary method 410 as describe with respect to FIG. 4A, the exemplary method 610 as describe with respect to FIG. 6, or the exemplary method 810 as describe with respect to FIG. 8.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 210 as describe with respect to FIG. 2A, the exemplary method 410 as describe with respect to FIG. 4A, the exemplary method 610 as describe with respect to FIG. 6, or the exemplary method 810 as describe with respect to FIG. 8.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 310 as describe with respect to FIG. 3A, the exemplary method 510 as describe with respect to FIG. 5A, the exemplary method 710 as describe with respect to FIG. 7, or the exemplary method 910 as describe with respect to FIG. 9.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 310 as describe with respect to FIG. 3A, the exemplary method 510 as describe with respect to FIG. 5A, the exemplary method 710 as describe with respect to FIG. 7, or the exemplary method 910 as describe with respect to FIG. 9.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

The present disclosure further provides the following embodiments:
1. A method (210) performed by a terminal device (1000), comprising:
   determining (212) whether a slot is an available slot for a physical uplink shared channel (PUSCH) repetition based at least in part on an amount X of symbols available for PUSCH transmission among L scheduled symbols for the PUSCH transmission in the slot; and
   performing (214, 216, 218) PUSCH repetitions through K available slots, wherein K is an amount of repetitions.
2. The method according to embodiment 1, wherein a slot is determined as an available slot in response to X is larger than or equal to a first threshold L1, and wherein L1 is less than or equal to L.
3. The method according to embodiment 2, wherein L and/or L1 is configured by a network node (1000) or predetermined.
4. The method according to any of embodiments 1 to 3, further comprising:
   receiving (222) a second threshold X1 from a network node (1000); and
   in a particular slot being not available slot and having X larger than or equal to X1, repeating (224) the X symbols available for the PUSCH transmission as the corresponding X symbols among the L scheduled symbols in a designated available slot.
5. The method according to embodiment 4, wherein the designated available slot is one of: a previous available slot, a subsequent available slot, and an available slot at a predetermined position, and wherein a redundancy version (RV) of the particular slot is the same as the designated available slot.
6. The method according to embodiment 4, wherein the PUSCH transmission in the particular slot is counted for RV cycling, and the designated available slot is an available slot having a same RV number as the particular slot.
7. The method according to any of embodiments 1 to 6, wherein a demodulation reference signal (DMRS) placement is determined based at least in part on a number of contiguous symbols available for PUSCH transmission among the L scheduled symbols in a slot; or the DMRS placement is configured by a network node (1000).
8. The method according to any of embodiments 4 to 6, wherein the values of X1 and L1 is configured by a radio resource control (RRC) message or downlink control information (DCI).
9. The method according to any of embodiments 1 to 8, wherein in response to the terminal device (1000) being not configured with a dynamic slot format indicator (SFI), semi-static flexible symbols are available for PUSCH repetition with dynamic grant, and an availability of semi-static flexible symbols for PUSCH repetition with configured grant is configured by a network node (1000) or predetermined.
10. The method according to any of embodiments 1 to 8, wherein in response to the terminal device (1000) being configured with a dynamic SFI, dynamic downlink (DL) symbols are unavailable, and the availability for PUSCH transmission of the dynamic flexible symbols is configured by DCI or pre-determined.
11. The method according to any of embodiments 1 to 8 and 10, wherein in response to the terminal device (1000) being configured with a dynamic SFI, for a PUSCH with configured grant, if at least one scheduled symbol in a certain slot is indicated as a DL symbol by the dynamic SFI, the certain slot is not the available slot and not counted for PUSCH repetition.
12. The method according to embodiment 11, wherein the transmission in the DL symbol in the certain slot is omitted, or the transmission in the certain slot is omitted.
13. The method according to any of embodiments 1 to 12, further comprising:
   receiving a third threshold X2 from a network node (1000); and
   in a slot having X larger than or equal to X2, allowing frequency hopping in the slot.
14. The method according to any of embodiments 1 to 13, further comprising:
   transmitting to a network node (1000) a report on whether the terminal device (1000) is capable of supporting extended number of PUSCH repetitions.
15. The method according to any of embodiments 1 to 14, wherein a value of K depends on a first type of the PUSCH repetition.
16. The method according to embodiment 15, further comprising:
   receiving configuration information about one or more PUSCH repetition types from a network node (1000), wherein the one or more PUSCH repetition types include the first type of the PUSCH repetition, and each of the one or more PUSCH repetition types supports at least one candidate value of K.
17. The method according to embodiment 16, further comprising:
   determining K and which of the one or more PUSCH repetition type is to be used by the terminal device (1000), based at least in part on RRC signaling, DCI signaling and/or a time domain resource assignment (TDRA) table, wherein the TDRA table is a default table or signaled from a network node (1000).
18. The method according to embodiment 17, wherein the first type of the PUSCH repetition and a different type of the one or more PUSCH repetition type which is determined based at least in part on the TDRA tables correspond to separate TDRA tables.
19. The method according to embodiment 17, wherein the first type of the PUSCH repetition and a different type of the one or more PUSCH repetition type which is determined based at least in part on the TDRA tables correspond to a same TDRA table.
20. The method according to any of embodiments 15 to 19, wherein the first type of the PUSCH repetition supports an extended number of PUSCH repetitions.
21. The method according to any of embodiments 16 to 20, wherein the one or more PUSCH repetition types further includes one or more of: a PUSCH repetition type A, a sub-type of the PUSCH repetition type A which supports an extended number of PUSCH repetitions, and a PUSCH repetition type B, wherein the one or more PUSCH repetition types are configured by an RRC message.
22. The method according to any of embodiments 16 to 20, wherein the one or more PUSCH repetition types includes: the first type of the PUSCH repetition, and the sub-type of the PUSCH repetition type A which supports an extended number of PUSCH repetitions, and wherein which of the configured types is to be used by the terminal device (1000) is indicated by RRC signaling, DCI signaling and/or a TDRA table.
23. A method (310) performed by a network node (1000), comprising: determining (312) whether a slot is an available slot for a physical uplink shared channel (PUSCH) repetition based at least in part on an amount X of symbols available for PUSCH transmission among L scheduled symbols for the PUSCH transmission in the slot; and
   receiving (314, 316, 318) PUSCH repetitions through equal to or less than K available slots, wherein K is a number of repetitions.
24. The method according to embodiment 23, wherein a slot is determined as an available slot in response to X is larger than or equal to a first threshold L1, and wherein L1 is less than or equal to L.
25. The method according to embodiment 24, wherein L and/or L1 is configured by a network node (1000) or predetermined.
26. The method according to any of embodiments 23 to 25, further comprising:
   informing (322) the terminal device (1000) of a second threshold X1; and
   instructing (324) the terminal device (1000) to repeat, in a particular slot being not available slot and having X larger than or equal to X1, the X symbols available for the PUSCH transmission as the corresponding X symbols among the L scheduled symbols in a designated available slot.
27. The method according to embodiment 26, wherein the designated available slot is one of: a previous available slot, a subsequent available slot, and an available slot at a predetermined position, and wherein a redundancy version (RV) of the particular slot is the same as the designated available slot.
28. The method according to embodiment 26, wherein the PUSCH transmission in the particular slot is counted for RV cycling, and the designated available slot is an available slot having a same RV cycling number as the particular slot.
29. The method according to any of embodiments 23 to 28, further comprising:
   determining a demodulation reference signal (DMRS) placement based at least in part on a number of contiguous symbols available for PUSCH transmission among the L scheduled symbols in a slot.
30. The method according to any of embodiments 23 to 28, further comprising:
   informing the terminal device (1000) of a configured DMRS placement.
31. The method according to any of embodiments 26 to 30, wherein the values of X1 and L1 is configured by a radio resource control (RRC) message or downlink control information (DCI).
32. The method according to any of embodiments 23 to 31, further comprising:
   configuring the terminal device (1000) without a dynamic slot format indicator (SFI), wherein semi-static flexible symbols are available for PUSCH repetition with dynamic grant, and an availability of semi-static flexible symbols for PUSCH repetition with configured grant is predetermined.
33. The method according to any of embodiments 23 to 31, further comprising:
   configuring the terminal device (1000) without a dynamic slot format indicator (SFI); and
   configuring an availability of semi-static flexible symbols for PUSCH repetition with configured grant;
   wherein semi-static flexible symbols are available for PUSCH repetition with dynamic grant.
34. The method according to any of embodiments 23 to 31, further comprising: configuring the terminal device (1000) with a dynamic SFI; and
   configuring the availability for PUSCH transmission of the semi-static flexible symbols by DCI.
35. The method according to any of embodiments 23 to 31, further comprising:
   configuring the terminal device (1000) with a dynamic SFI;
   wherein for a PUSCH with configured grant, if at least one scheduled symbol in a certain slot is indicated as a DL symbol by the dynamic SFI, the certain slot is not the available slot and not counted for PUSCH repetition.
36. The method according to embodiment 35, wherein the transmission in the DL symbol in the certain slot is omitted, or the transmission in the certain slot is omitted.
37. The method according to any of embodiments 23 to 36, further comprising:
   informing the terminal device (1000) of a second threshold X2; and
   in a slot having X larger than or equal to X2, informing the terminal device (1000) of allowance of frequency hopping in the slot.
38. The method according to any of embodiments 23 to 37, further comprising:
   receiving a report on whether the terminal device (1000) is capable of supporting extended number of repetitions.
39. The method according to any of embodiments 23 to 38, wherein a value of K depends on a first type of the PUSCH repetition.
40. The method according to embodiment 39, further comprising:
   sending to the terminal device (1000) configuration information about one or more PUSCH repetition types, wherein the one or more PUSCH repetition types include the first type of the PUSCH repetition, and each of the one or more PUSCH repetition types supports at least one candidate value of K.
41. The method according to embodiment 40, further comprising:
   informing the terminal device (1000) of K and which of the one or more PUSCH repetition type is to be used by the terminal device (1000) based at least in part by RRC signaling, DCI signaling and/or a time domain resource assignment (TDRA) table, wherein the TDRA table is a default table or signaled from a network node (1000).
42. The method according to embodiment 41, wherein the first type of the PUSCH repetition and a different type of the one or more PUSCH repetition type which is determined based at least in part on the TDRA tables correspond to separate TDRA tables.
43. The method according to embodiment 41, wherein the first type of the PUSCH repetition and a different type of the one or more PUSCH repetition type which is determined based at least in part on the TDRA tables correspond to a same TDRA table.
44. The method according to any of embodiments 39 to 43, wherein the first type of the PUSCH repetition supports an extended number of repetitions.
45. The method according to any of embodiments 40 to 44, wherein the one or more PUSCH repetition types further includes one or more of: a PUSCH repetition type A, a sub-type of the PUSCH repetition type A which supports an extended number of PUSCH repetitions, and a PUSCH repetition type B, wherein the one or more PUSCH repetition types are configured by an RRC message.
46. The method according to any of embodiments 40 to 44, wherein the one or more PUSCH repetition types includes: the first type of the PUSCH repetition, and the sub-type of the PUSCH repetition type A which supports an extended number of PUSCH repetitions, and wherein the method further comprises:
   indicating which of the configured types is to be used by the terminal device (1000) by RRC signaling, DCI signaling and/or a TDRA table.
47. A terminal device (1000), comprising:
   one or more processors (1001); and
   one or more memories (1002) comprising computer program codes (1003),
   the one or more memories (1002) and the computer program codes (1003) configured to, with the one or more processors (1001), cause the terminal device (1000) at least to:
      determine whether a slot is an available slot for a physical uplink shared channel (PUSCH) repetition based at least in part on an amount X of symbols available for PUSCH transmission among L scheduled symbols for the PUSCH transmission in the slot; and
      perform PUSCH repetitions through K available slots, wherein K is an amount of repetitions.
48. The terminal device (1000) according to embodiment 47, wherein the one or more memories (1002) and the computer program codes (1003) are configured to, with the one or more processors (1001), cause the terminal device (1000) to perform the method according to any one of embodiments 2 to 22.
49. A computer-readable medium having computer program codes (1003) embodied thereon which, when executed on a computer, cause the computer to perform any step of the method according to any one of embodiments 1 to 22.
50. A network node (1000), comprising:
   one or more processors (1001); and
   one or more memories (1002) comprising computer program codes (1003),
   the one or more memories (1002) and the computer program codes (1003) configured to, with the one or more processors (1001), cause the network node (1000) at least to:
      determine whether a slot is an available slot for a physical uplink shared channel (PUSCH) repetition based at least in part on an amount X of symbols available for PUSCH transmission among L scheduled symbols for the PUSCH transmission in the slot; and
      receive PUSCH repetitions through equal to or less than K available slots, wherein K is a number of repetitions.
51. The network node (1000) according to embodiment 50, wherein the one or more memories (1002) and the computer program codes (1003) are configured to, with the one or more processors (1001), cause the network node (1000) to perform the method according to any one of embodiments 23 to 46.
52. A computer-readable medium having computer program codes (1003) embodied thereon which, when executed on a computer, cause the computer to perform any step of the method according to any one of embodiments 23 to 46.
53. A method (410) performed by a terminal device (1000), comprising:
   transmitting (412) to a network node (1000) a report on one or more physical uplink shared channel (PUSCH) repetition types supported by the terminal device (1000).
54. The method according to embodiment 53, wherein the one or more PUSCH repetition types includes one or more of: a PUSCH repetition type A, a first sub-type of the PUSCH repetition type A, a second sub-type of the PUSCH repetition type A, and a PUSCH repetition type B,
   wherein the first sub-type supports an extended number of PUSCH repetitions,
   wherein according to the second sub-type, only the PUSCH transmission in an available slot is counted for PUSCH repetition, and wherein whether a slot is the available slot is determined based at least in part on an amount X of symbols available for PUSCH transmission among L scheduled symbols for the PUSCH transmission in the slot.
55. The method according to embodiment 54, wherein a slot is determined as an available slot in response to X is larger than or equal to a first threshold L1, and wherein L1 is less than or equal to L.
56. The method according to embodiment 55, wherein L and/or L1 is configured by a network node (1000) or predetermined.
57. The method according to any of embodiments 54 to 56, wherein in response to the terminal device's capability of supporting the PUSCH repetition type B being reported to the network node (1000), the terminal device's capability of supporting the second sub-type of the PUSCH repetition type A does not need to be reported to the network node (1000).
58. The method according to any of embodiments 54 to 57, wherein the second sub-type of the PUSCH repetition type A is capable of supporting extended number of PUSCH repetitions.
59. The method according to any of embodiments 53 to 58, wherein the terminal device (1000) is configured with one of the one or more PUSCH repetition types.
60. The method according to any of embodiments 53 to 58, wherein the terminal device (1000) is configured, by an RRC message, with at least two of: the first sub-type of the PUSCH repetition type A, the second sub-type of the PUSCH repetition type A, and the PUSCH repetition type B.
61. The method according to embodiment 60, wherein in response to the terminal device (1000) being configured with the first sub-type and the second sub-type of the PUSCH repetition type A, which of the configured types is to be used by the terminal device (1000) is indicated by DCI signaling and/or a time domain resource assignment (TDRA) table.
62. The method according to embodiment 53, wherein the one or more PUSCH repetition types includes a PUSCH repetition type A and a PUSCH repetition type B, the terminal device (1000) is configured, by an RRC message, with one of the PUSCH repetition type A and the PUSCH repetition type B.
63. The method according to embodiment 62, wherein the PUSCH repetition type A comprises a first sub-type and a second sub-type;
   wherein the first sub-type supports an extended number of PUSCH repetitions;
   wherein according to the second sub-type, only the PUSCH transmission in an available slot is counted for PUSCH repetition, and wherein whether a slot is the available slot is determined based at least in part on an amount X of symbols available for PUSCH transmission among L scheduled symbols for the PUSCH transmission in the slot; and
   wherein in response to the terminal device (1000) being configured with the PUSCH repetition type A, which sub-type of the PUSCH repetition type A is to be used by the terminal device (1000) is predetermined, or indicated by DCI signaling and/or a time domain resource assignment (TDRA) table.
64. The method according to any of embodiments 54 to 58, embodiments 60 to 61 and embodiment 63, wherein the first sub-type of the PUSCH repetition type A and the second sub-type of the PUSCH repetition type A correspond to separate TDRA tables.
65. The method according to any of embodiments 54 to 58, embodiments 60 to 61 and embodiment 63, wherein the first sub-type of the PUSCH repetition type A and the second sub-type of the PUSCH repetition type A correspond to a same TDRA table.
66. A method (510) performed by a network node (1000), comprising:
   receiving (512) from a terminal device (1000) a report on one or more physical uplink shared channel (PUSCH) repetition types supported by the terminal device (1000).
67. The method according to embodiment 66, wherein the one or more PUSCH repetition types includes one or more of: a PUSCH repetition type A, a first sub-type of the PUSCH repetition type A, a second sub-type of the PUSCH repetition type A, and a PUSCH repetition type B,
   wherein the first sub-type supports an extended number of PUSCH repetitions,
   wherein according to the second sub-type, only the PUSCH transmission in an available slot is counted for PUSCH repetition, and wherein whether a slot is the available slot is determined based at least in part on an amount X of symbols available for PUSCH transmission among L scheduled symbols for the PUSCH transmission in the slot.
68. The method according to embodiment 67, wherein a slot is determined as an available slot in response to X is larger than or equal to a first threshold L1, and wherein L1 is less than or equal to L.
69. The method according to embodiment 68, wherein L and/or L1 is configured by a network node (1000) or predetermined.
70. The method according to any of embodiments 67 to 69, further comprising:
   determining, in response to the terminal device (1000) supporting the PUSCH repetition type B, that the terminal device (1000) supports the second sub-type of the PUSCH repetition type A.
71. The method according to any of embodiments 67 to 70, wherein the second sub-type of the PUSCH repetition type A is capable of supporting extended number of PUSCH repetitions.
72. The method according to any of embodiments 66 to 71, further comprising:
   configuring the terminal device (1000) with one of the one or more PUSCH repetition types.
73. The method according to any of embodiments 66 to 71, further comprising:
   configuring the terminal device (1000), by an RRC message, with at least two of: the first sub-type of the PUSCH repetition type A, the second sub-type of the PUSCH repetition type A, and the PUSCH repetition type B.
74. The method according to any of embodiments 66 to 71, further comprising:
   configuring the terminal device (1000), by an RRC message, with the first sub-type and the second sub-type of the PUSCH repetition type A; and
   indicating which of the configured types is to be used by the terminal device (1000) by DCI signaling and/or a time domain resource assignment (TDRA) table.
75. The method according to embodiment 63, wherein the one or more PUSCH repetition types includes a PUSCH repetition type A and a PUSCH repetition type B, and the method further comprises:
   configuring the terminal device (1000), by an RRC message, with one of the PUSCH repetition type A and the PUSCH repetition type B.
76. The method according to embodiment 75, wherein the PUSCH repetition type A comprises a first sub-type and a second sub-type;
   wherein the first sub-type supports an extended number of PUSCH repetitions;
   wherein according to the second sub-type, only the PUSCH transmission in an available slot is counted for PUSCH repetition, and wherein whether a slot is the available slot is determined based at least in part on an amount X of symbols available for PUSCH transmission among L scheduled symbols for the PUSCH transmission in the slot; and
   wherein the method further comprises:
   configuring the terminal device (1000) with the PUSCH repetition type A.
77. The method according to embodiment 76, further comprising:
   indicating which sub-type of the PUSCH repetition type A is to be used by the terminal device (1000) by DCI signaling and/or a time domain resource assignment (TDRA) table.
78. The method according to any of embodiments 67 to 71, embodiments 73 to 74 and embodiments 76 to 77, wherein the first sub-type of the PUSCH repetition type A and the second sub-type of the PUSCH repetition type A correspond to separate TDRA tables.
79. The method according to any of embodiments 67 to 71, embodiments 73 to 74 and embodiments 76 to 77, wherein the first sub-type of the PUSCH repetition type A and the second sub-type of the PUSCH repetition type A correspond to a same TDRA table.
80. A terminal device (1000), comprising:
   one or more processors (1001); and
   one or more memories (1002) comprising computer program codes (1003),
   the one or more memories (1002) and the computer program codes (1003) configured to, with the one or more processors (1001), cause the terminal device (1000) at least to:
      transmit to a network node (1000) a report on one or more physical uplink shared channel (PUSCH) repetition types supported by the terminal device (1000).
81. The terminal device (1000) according to embodiment 80, wherein the one or more memories (1002) and the computer program codes (1003) are configured to, with the one or more processors (1001), cause the terminal device (1000) to perform the method according to any one of embodiments 54 to 65.
82. A computer-readable medium having computer program codes (1003) embodied thereon which, when executed on a computer, cause the computer to perform any step of the method according to any one of embodiments 53 to 65.
83. A network node (1000), comprising:
   one or more processors (1001); and
   one or more memories (1002) comprising computer program codes (1003),
   the one or more memories (1002) and the computer program codes (1003) configured to, with the one or more processors (1001), cause the network node (1000) at least to:
      receive from a terminal device (1000) a report on one or more physical uplink shared channel (PUSCH) repetition types supported by the terminal device (1000).
84. The network node (1000) according to embodiment 83, wherein the one or more memories (1002) and the computer program codes (1003) are configured to, with the one or more processors (1001), cause the network node (1000) to perform the method according to any one of embodiments 67 to 79.
85. A computer-readable medium having computer program codes (1003) embodied thereon which, when executed on a computer, cause the computer to perform any step of the method according to any one of embodiments 66 to 79.

The present disclosure further provides the following embodiments:
1. A method (610) in a terminal device, comprising:
   receiving (612), from a network node, at least one of cell specific Time Division Duplex, TDD, uplink-downlink configuration information and User Equipment, UE, specific TDD uplink-downlink configuration information; and
   determining (614) whether a slot is available for Physical Uplink Shared Channel, PUSCH, repetition based on the at least one of the cell specific TDD uplink-downlink configuration information and the UE specific TDD uplink-downlink configuration information.
2. The method (610) of embodiment 1, wherein said determining (614) comprises:
   determining the slot to be unavailable for PUSCH repetition when the slot is configured as downlink by the at least one of the cell specific TDD uplink-downlink configuration information and the UE specific TDD uplink-downlink configuration information.
3. The method (610) of embodiment 1 or 2, wherein said determining (614) comprises:
   determining the slot to be available for PUSCH repetition when the slot includes no symbol that is configured as downlink by the at least one of the cell specific TDD uplink-downlink configuration information and the UE specific TDD uplink-downlink configuration information and overlaps any symbol in a set of symbols indicated by PUSCH Time Domain Resource Allocation, TDRA.
4. The method (610) of embodiment 1 or 2, wherein said determining (614) comprises:
   determining the slot to be available for PUSCH repetition when the slot is configured as uplink by the at least one of the cell specific TDD uplink-downlink configuration information and the UE specific TDD uplink-downlink configuration information, or includes a set of symbols, indicated by PUSCH Time Domain Resource Allocation, TDRA, each configured as uplink or flexible by the at least one of the cell specific TDD uplink-downlink configuration information and the UE specific TDD uplink-downlink configuration information.
5. The method (610) of any of embodiments 1-4, further comprising:
   receiving, from the network node, control information indicating the at least one of the cell specific TDD uplink-downlink configuration information and the UE specific TDD uplink-downlink configuration information to be used for determining whether the slot is available for PUSCH repetition.
6. The method (610) of any of embodiments 1-4, wherein
   said determining (614) is based on the cell specific TDD uplink-downlink configuration information when only the cell specific TDD uplink-downlink configuration information is received, or
   said determining (614) is based on both the cell specific TDD uplink-downlink configuration information and the UE specific TDD uplink-downlink configuration information when both the cell specific TDD uplink-downlink configuration information and the UE specific TDD uplink-downlink configuration information are received.
7. The method (610) of embodiment 3 or 4, further comprising:
   determining whether to transmit the PUSCH repetition in the slot in accordance with Radio Resource Control, RRC, signaling or Downlink Control Information, DCI, from the network node, or with a predetermined rule, when at least one symbol in the set of symbols is configured as flexible by the at least one of the cell specific TDD uplink-downlink configuration information and the UE specific TDD uplink-downlink configuration information and no dynamic Slot Format Indication, SFI, for the slot is received from the network node.
8. The method (610) of embodiment 7, wherein said determining whether to transmit the PUSCH repetition in the slot in accordance with the predetermined rule comprises: determining to transmit the PUSCH repetition in the slot regardless of whether the terminal device is configured with enableConfiguredUL.
9. The method (610) of embodiment 3 or 4, further comprising:
   identifying an error case when at least one symbol in the set of symbols is configured as flexible by the at least one of the cell specific TDD uplink-downlink configuration information and the UE specific TDD uplink-downlink configuration information and indicated as downlink or flexible in a dynamic Slot Format Indication, SFI, for the slot as received from the network node.
10. The method (610) of embodiment 3 or 4, further comprising:
   identifying an error case when at least one symbol in the set of symbols is configured as flexible by the at least one of the cell specific TDD uplink-downlink configuration information and the UE specific TDD uplink-downlink configuration information and indicated as downlink in a dynamic Slot Format Indication, SFI, for the slot as received from the network node.
11. The method (610) of embodiment 3 or 4, further comprising:
   transmitting the PUSCH repetition in the slot when each symbol in the set of symbols that is configured as flexible by the at least one of the cell specific TDD uplink-downlink configuration information and the UE specific TDD uplink-downlink configuration information is indicated as uplink in a dynamic Slot Format Indication, SFI, for the slot as received from the network node.
12. The method (610) of embodiment 3 or 4, further comprising, when a subset of the set of symbols is indicated as downlink or flexible in a dynamic Slot Format Indication, SFI, for the slot as received from the network node:
   transmitting the PUSCH repetition in symbols in the subset that are earlier than a timer after a last symbol of a Physical Downlink Control Channel, PDCCH, in which the dynamic SFI is received; and
   cancelling the PUSCH repetition in remaining symbols in the subset.
13. The method (610) of embodiment 12, wherein the timer is a PUSCH preparation timer.
14. The method (610) of any of embodiments 1-11, wherein the cell specific TDD uplink-downlink configuration information is tdd-UL-DL-ConfigurationCommon and the UE specific TDD uplink-downlink configuration information is tdd-UL-DL-ConfigurationDedicated.
15. The method (610) of any of embodiments 1-12, wherein the PUSCH repetition comprises a Dynamic Grant, DG, -PUSCH, a Type-1 Configured Grant, CG, -PUSCH, or a Type-2 CG-PUSCH.
16. A method (810) in a terminal device, comprising:
   determining (812) a slot to be available for Physical Uplink Shared Channel, PUSCH, repetition in absence of cell specific Time Division Duplex, TDD, uplink-downlink configuration information and User Equipment, UE, specific TDD uplink-downlink configuration information from a network node for the slot.
17. The method (810) of embodiment 16, further comprising:
   determining whether to transmit the PUSCH repetition in the slot in accordance with Radio Resource Control, RRC, signaling or Downlink Control Information, DCI, from the network node, or with a predetermined rule, when no dynamic Slot Format Indication, SFI, for the slot is received from the network node.
18. The method (810) of embodiment 17, wherein said determining whether to transmit the PUSCH repetition in the slot in accordance with the predetermined rule comprises: determining to transmit the PUSCH repetition in the slot regardless of whether the terminal device is configured with enableConfiguredUL.
19. The method (810) of embodiment 16, further comprising:
   identifying an error case when at least one symbol in a set of symbols indicated by PUSCH Time Domain Resource Allocation, TDRA, is indicated as downlink or flexible in a dynamic Slot Format Indication, SFI, for the slot as received from the network node.
20. The method (810) of embodiment 16, further comprising:
   identifying an error case when at least one symbol in a set of symbols indicated by PUSCH Time Domain Resource Allocation, TDRA, is indicated as downlink in a dynamic Slot Format Indication, SFI, for the slot as received from the network node.
21. The method (810) of embodiment 16, further comprising:
   transmitting the PUSCH repetition in the slot when each symbol in a set of symbols indicated by PUSCH Time Domain Resource Allocation, TDRA, is indicated as uplink in a dynamic Slot Format Indication, SFI, for the slot as received from the network node.
22. The method (810) of embodiment 16, further comprising, when a subset of a set of symbols indicated by PUSCH Time Domain Resource Allocation, TDRA, is indicated as downlink or flexible in a dynamic Slot Format Indication, SFI, for the slot as received from the network node:
   transmitting the PUSCH repetition in symbols in the subset that are earlier than a timer after a last symbol of a Physical Downlink Control Channel, PDCCH, in which the dynamic SFI is received; and
   cancelling the PUSCH repetition in remaining symbols in the subset.
23. The method (810) of embodiment 22, wherein the timer is a PUSCH preparation timer.
24. The method (810) of any of embodiments 16-23, wherein the cell specific TDD uplink-downlink configuration information is tdd-UL-DL-ConfigurationCommon and the UE specific TDD uplink-downlink configuration information is tdd-UL-DL-ConfigurationDedicated.
25. The method of any of embodiments 16-24, wherein the PUSCH repetition comprises a Dynamic Grant, DG, -PUSCH, a Type-1 Configured Grant, CG, -PUSCH, or a Type-2 CG-PUSCH.
26. A terminal device (1000), comprising a processor (1001) and a memory (1002), the memory (1002) comprising instructions executable by the processor (1001) whereby the terminal device (1000) is operative to perform the method according to any of embodiments 1-25.
27. A computer-readable storage medium having computer-readable instructions stored thereon, the computer-readable instructions, when executed by a processor of a terminal device, configure the terminal device to perform the method according to any of embodiments 1-25.
28. A method (710) in a network node, comprising:
   transmitting (712), to a terminal device, at least one of cell specific Time Division Duplex, TDD, uplink-downlink configuration information and User Equipment, UE, specific TDD uplink-downlink configuration information; and
   determining (714) whether a slot is available for Physical Uplink Shared Channel, PUSCH, repetition based on the at least one of the cell specific TDD uplink-downlink configuration information and the UE specific TDD uplink-downlink configuration information.
29. The method (710) of embodiment 28, wherein said determining (714) comprises:
   determining the slot to be unavailable for PUSCH repetition when the slot is configured as downlink by the at least one of the cell specific TDD uplink-downlink configuration information and the UE specific TDD uplink-downlink configuration information.
30. The method (710) of embodiment 28 or 29, wherein said determining (714) comprises:
   determining the slot to be available for PUSCH repetition when the slot includes no symbol that is configured as downlink by the at least one of the cell specific TDD uplink-downlink configuration information and the UE specific TDD uplink-downlink configuration information and overlaps any symbol in a set of symbols indicated by PUSCH Time Domain Resource Allocation, TDRA.
31. The method (710) of embodiment 28 or 29, wherein said determining (714) comprises:
   determining the slot to be available for PUSCH repetition when the slot is configured as uplink by the at least one of the cell specific TDD uplink-downlink configuration information and the UE specific TDD uplink-downlink configuration information, or includes a set of symbols, indicated by PUSCH Time Domain Resource Allocation, TDRA, each configured as uplink or flexible by the at least one of the cell specific TDD uplink-downlink configuration information and the UE specific TDD uplink-downlink configuration information.
32. The method (710) of any of embodiments 28-31, further comprising:
   transmitting, to the terminal device, control information indicating the at least one of the cell specific TDD uplink-downlink configuration information and the UE specific TDD uplink-downlink configuration information to be used for determining whether the slot is available for PUSCH repetition.
33. The method (710) of embodiment 30 or 31, further comprising, when at least one symbol in the set of symbols is configured as flexible by the at least one of the cell specific TDD uplink-downlink configuration information and the UE specific TDD uplink-downlink configuration information and no dynamic Slot Format Indication, SFI, for the slot is transmitted to the terminal device:
   transmitting, to the terminal device, Radio Resource Control, RRC, signaling or Downlink Control Information, DCI, indicating whether the terminal device is to transmit the PUSCH repetition in the slot; or determining whether to receive the PUSCH repetition in the slot in accordance with a predetermined rule.
34. The method (710) of embodiment 33, wherein said determining whether to receive the PUSCH repetition in the slot in accordance with the predetermined rule comprises: determining to receive the PUSCH repetition in the slot regardless of whether the terminal device is configured with enableConfiguredUL.
35. The method (710) of embodiment 30 or 31, further comprising:
   transmitting, to the terminal device, a dynamic Slot Format Indication, SFI, for the slot, the dynamic SFI indicating each symbol in the set of symbols that is configured as flexible by the at least one of the cell specific TDD uplink-downlink configuration information and the UE specific TDD uplink-downlink configuration information as uplink; and
   receiving the PUSCH repetition in the slot.
36. The method (710) of embodiment 30 or 31, further comprising:
   transmitting, to the terminal device, a dynamic Slot Format Indication, SFI, for the slot, the dynamic SFI indicating a subset of the set of symbols as downlink or flexible; and
   receiving the PUSCH repetition in symbols in the subset that are earlier than a timer after a last symbol of a Physical Downlink Control Channel, PDCCH, in which the dynamic SFI is transmitted, but not in remaining symbols in the subset.
37. The method (710) of embodiment 36, wherein the timer is a PUSCH preparation timer.
38. The method (710) of any of embodiments 28-37, wherein the cell specific TDD uplink-downlink configuration information is tdd-UL-DL-ConfigurationCommon and the UE specific TDD uplink-downlink configuration information is tdd-UL-DL-ConfigurationDedicated.
39. The method (710) of any of embodiments 28-38, wherein the PUSCH repetition comprises a Dynamic Grant, DG, -PUSCH, a Type-1 Configured Grant, CG, -PUSCH, or a Type-2 CG-PUSCH.
40. A method (910) in a network node, comprising:
   determining (912) a slot to be available for Physical Uplink Shared Channel, PUSCH, repetition in absence of cell specific Time Division Duplex, TDD, uplink-downlink configuration information and User Equipment, UE, specific TDD uplink-downlink configuration information from a network node for the slot.
41. The method (910) of embodiment 40, further comprising, when no dynamic Slot Format Indication, SFI, for the slot is transmitted to the terminal device:
   transmitting, to the terminal device, Radio Resource Control, RRC, signaling or Downlink Control Information, DCI, indicating whether the terminal device is to transmit the PUSCH repetition in the slot; or determining whether to receive the PUSCH repetition in the slot in accordance with a predetermined rule.
42. The method (910) of embodiment 41, wherein said determining whether to receive the PUSCH repetition in the slot in accordance with the predetermined rule comprises: determining to receive the PUSCH repetition in the slot regardless of whether the terminal device is configured with enableConfiguredUL.
43. The method (910) of embodiment 40, further comprising:
   transmitting, to the terminal device, a dynamic Slot Format Indication, SFI, for the slot, the dynamic SFI indicating each symbol in a set of symbols indicated by PUSCH Time Domain Resource Allocation, TDRA, is indicated as uplink; and
   receiving the PUSCH repetition in the slot.
44. The method (910) of embodiment 40, further comprising:
   transmitting, to the terminal device, a dynamic Slot Format Indication, SFI, for the slot, the dynamic SFI indicating a subset of the set of symbols as downlink or flexible; and
   receiving the PUSCH repetition in symbols in the subset that are earlier than a timer after a last symbol of a Physical Downlink Control Channel, PDCCH, in which the dynamic SFI is transmitted, but not in remaining symbols in the subset.
45. The method (910) of embodiment 44, wherein the timer is a PUSCH preparation timer.
46. The method (910) of any of embodiments 40-45, wherein the cell specific TDD uplink-downlink configuration information is tdd-UL-DL-ConfigurationCommon and the UE specific TDD uplink-downlink configuration information is tdd-UL-DL-ConfigurationDedicated.
47. The method (910) of any of embodiments 40-46, wherein the PUSCH repetition comprises a Dynamic Grant, DG, -PUSCH, a Type-1 Configured Grant, CG, -PUSCH, or a Type-2 CG-PUSCH.
48. A network node (1000), comprising a processor (1001) and a memory (1002), the memory (1002) comprising instructions executable by the processor (1001) whereby the network node (1000) is operative to perform the method according to any of embodiments 28-47.
49. A computer-readable storage medium having computer-readable instructions stored thereon, the computer-readable instructions, when executed by a processor of a network node, configure the network node to perform the method according to any of embodiments 28-47.

1. A method performed by a terminal device, comprising:
determining a slot to be an available slot for a physical uplink shared channel, PUSCH, repetition based at least in part on an amount X of symbols available for PUSCH transmission being equal to L scheduled symbols for the PUSCH transmission in the slot; and
performing PUSCH repetitions through K determined available slots, wherein K is an amount of the PUSCH repetitions.

2. (canceled)

3. The method according to claim 1, wherein redundancy version, RV, cycling is counted based on the determined available slots for the PUSCH transmission.

4. The method according to claim 1, further comprising:
transmitting to a network node a report on whether the terminal device is capable of supporting an extended number of PUSCH repetitions, wherein the extended number of PUSCH repetitions is greater than a number of PUSCH repetitions supported by a terminal device that is not capable of supporting the extended number of PUSCH repetitions.

5. The method according to claim 1, wherein a value of K depends on a first type of the PUSCH repetition.

6. The method according to claim 5, further comprising:
receiving configuration information about one or more PUSCH repetition types from a network node, wherein the one or more PUSCH repetition types include the first type of the PUSCH repetition, and each of the one or more PUSCH repetition types supports at least one candidate value of K.

7.-9. (canceled)

10. The method according to claim 5, wherein the first type of the PUSCH repetition supports an extended number of PUSCH repetitions.

11.-12. (canceled)

13. The method according to claim 4, wherein the report comprises a report on one or more PUSCH repetition types supported by the terminal device.

14. (canceled)

15. The method according to claim 13, wherein the terminal device is configured with one of the one or more PUSCH repetition types.

16.-18. (canceled)

19. A method performed by a network node, comprising:
determining a slot to be an available slot for a physical uplink shared channel, PUSCH, repetition based at least in part on an amount X of symbols available for PUSCH transmission being equal to L scheduled symbols for the PUSCH transmission in the slot; and
receiving PUSCH repetitions through equal to or less than K determined available slots, wherein K is a number of the PUSCH repetitions.

20. (canceled)

21. The method according to claim 19, wherein redundancy version, RV, cycling is counted based on the determined available slots for the PUSCH transmission.

22. The method according to claim 19, further comprising:
receiving a report on whether the terminal device is capable of supporting extended number of PUSCH repetitions, wherein the extended number of PUSCH repetitions is greater than a number of PUSCH repetitions supported by a terminal device that is not capable of supporting the extended number of PUSCH repetitions.

23. The method according to claim 19, wherein a value of K depends on a first type of the PUSCH repetition.

24. The method according to claim 23, further comprising:
sending to the terminal device configuration information about one or more PUSCH repetition types, wherein the one or more PUSCH repetition types include the first type of the PUSCH repetition, and each of the one or more PUSCH repetition types supports at least one candidate value of K.

25.-27. (canceled)

28. The method according to claim 23, wherein the first type of the PUSCH repetition supports an extended number of PUSCH repetitions.

29.-59. (canceled)

60. A terminal device, comprising a processor and a memory, the memory comprising instructions executable by the processor whereby the terminal device is operative to:
determine a slot to be an available slot for a physical uplink shared channel, PUSCH, repetition based at least in part on an amount X of symbols available for PUSCH transmission being equal to L scheduled symbols for the PUSCH transmission in the slot; and
perform PUSCH repetitions through K determined available slots, wherein K is an amount of the PUSCH repetitions.

61. (canceled)

62. A network node, comprising a processor and a memory, the memory comprising instructions executable by the processor whereby the network node is operative to:
determine a slot to be an available slot for a physical uplink shared channel, PUSCH, repetition based at least in part on an amount X of symbols available for PUSCH transmission being equal to L scheduled symbols for the PUSCH transmission in the slot; and
receive PUSCH repetitions through equal to or less than K determined available slots, wherein K is a number of the PUSCH repetitions.

63. (canceled)
